(19) United States
(12) Patent Application Publication
(10) Pub. No.: US 2017/0372449 A1
(43) Pub. Date: Dec. 28, 2017

(54) SMART CAPTURING OF WHITEBOARD CONTENTS FOR REMOTE CONFERENCING

(71) Applicant: INTEL CORPORATION, SANTA CLARA, CA (US)

(72) Inventors: MARK D. YARVIS, PORTLAND, OR (US); FAN CHEN, PORTLAND, OR (US); CHRISTOPHER J. LORD, PORTLAND, OR (US); MATTHEW E. FRAZER, TIGARD, OR (US); ASHWIN PATTI, FREMONT, CA (US)

(21) Appl. No.: 15/192,476

(22) Filed: Jun. 24, 2016

(51) Int. Cl. G06T 3/00; H04N 5/232; H04N 5/265

(52) U.S. Cl. CPC G06T 3/0018; H04N 5/265; H04N 5/23238; G06T 2207/10004

(57) ABSTRACT

A mechanism is described for facilitating smart capturing of whiteboard contents according to one embodiment. A method of embodiments, as described herein, includes capturing, by one or more cameras of a computing device, one or more images of one or more boards, and identifying a target board of the one or more boards using one or more indicators associated with the target board, where identifying the target board includes extracting a region encompassing the target board. The method may further include estimating scene geometry based on the region, and generating a rectified image of the target board based on the scene geometry.

### FIELD

Embodiments described herein generally relate to computers. More particularly, embodiments relate to facilitating smart capturing of whiteboard contents for remote conferencing.

### BACKGROUND

Remote conferencing has been a general practice for productive team collaboration with reduced travel time and cost, where effective sharing of various information between local and remote attendees is essential for smooth communication. The use of whiteboards remains as a low-cost, user-friendly way for presenting textual and/or graphical information that is difficult to clearly explain using only verbal communication; however, despite the availability of low-cost cameras for video conferencing, it remains challenging for a remote meeting participant to effectively see the whiteboard. Such challenges are typically due to geometrical distortions, lack of clarity, viewing biases, inconsistent camera placements, and/or the like. Further, conventional techniques do not properly handle occlusion removal, such as leaving parts of the foreground in the background region, leading to a trail of foreground objects in the output frame.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a smart whiteboard capturing mechanism according to one embodiment.

FIG. 2 illustrates a smart whiteboard capturing mechanism according to one embodiment.

FIG. 3A illustrates a panoramic image of a conference room according to one embodiment.

FIG. 3B illustrates whiteboard indicators according to one embodiment.

FIG. 3C illustrates a resultant rectified image of a whiteboard that is identified and rectified according to one embodiment.

FIG. 3D illustrates a contrast-enhanced output representing a final result of the whiteboard according to one embodiment.

FIG. 3E illustrates a whiteboard rectification technique for correcting geometrical distortions to provide a frontal and clear view of whiteboard contents of a whiteboard according to one embodiment.

FIG. 4A illustrates a method for facilitating whiteboard identification and rectification according to one embodiment.

FIG. 4B illustrates a method for facilitating whiteboard identification according to one embodiment.

FIG. 4C illustrates a method for facilitating automatic estimation of aspect ratio according to one embodiment.

FIG. 4D illustrates a method for facilitating whiteboard rectification according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

FIG. 7A illustrates an input panoramic image showing a severely distorted view of a whiteboard according to one embodiment.

FIG. 7B illustrates a panoramic image showing removal of distortion from a view of a whiteboard according to one embodiment.

FIG. 7C illustrates an input panoramic image showing estimated vanishing points relating to a whiteboard according to one embodiment.

FIG. 8A illustrates a method for facilitating vanishing points extraction from a stitched image according to one embodiment.

FIG. 8B illustrates a method for facilitating correction of lens-distortion in a stitched image according to one embodiment.

FIG. 9A illustrates a method for whiteboard occlusion removal according to one embodiment.

FIG. 9B illustrates a method for facilitating creation of an edge mask according to one embodiment.

FIG. 9C illustrates a method for facilitating creation of an output frame according to one embodiment.

FIG. 10A illustrates a panoramic image of a conference room according to one embodiment.

FIG. 10B illustrates a rectified whiteboard image of a whiteboard in a conference room according to one embodiment.

FIG. 10C illustrates a contrast enhanced whiteboard image of a whiteboard in a conference room according to one embodiment.

FIG. 11A illustrates a method for facilitating contrast enhancement on rectified images according to one embodiment.

FIG. 11B illustrates a graph of a mapping function used for contrast enhancement of FIG. 11A according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for presenting to a remote meeting participant a clearer frontal-view of a whiteboard, regardless of camera placement. In one embodiment, a conference room's geometry may be taken into consideration for identifying and rectifying one or more whiteboards in the conference room for enhancing and clarifying a whiteboard's contents.

Embodiments provide for a novel technique for identifying a whiteboard region from an image sequence of the conference room and rectify the whiteboard region into a frontal-view image of the whiteboard by correcting its geometrical distortion. Further, an aspect ratio of the rectified whiteboard may be automatically estimated.

Embodiments provide for a novel technique for providing a vanishing point estimation from a stitched panoramic image for understanding a scene geometry. For example, vanishing points of the conference room are estimated from a stitched image sequence as captured by a panoramic camera, including using a novel technique for lens un-distortion for stitched panoramic images.

Embodiments provide for a novel technique for contrast enhancement of a whiteboard image from a panoramic camera, so that any whiteboard content can be clearly viewed and shared under various lighting conditions, which may include local meeting attendees, such as when a whiteboard is hard to see from a person's viewing angle or under poor lighting conditions.

Embodiments provide for a novel technique for distinguishing foreground objects (e.g., occluding objects) from a background (e.g., whiteboard region) and present an occlusion-free whiteboard region.

Although throughout this document, term “whiteboard” is used, but it is contemplated that embodiments are not limited to any writing board being “white” in color and that such boards may be of varying colors, as necessitated or desired. Similarly, embodiments are not limited to such boards being of certain size or shape, such as rectangular, and that they may be of any size and shape, as necessitated or desired. Further, throughout this document, term “conference room” is used, but is contemplated that embodiments are not limited as such that a room may be any physical area of any size, shape, or type, such as a bedroom, a living room, a kitchen, an office, and/or the like. Further, “whiteboard” may include any type of writing or printing boards, such as a chalkboard, and be made of any material, such as plastic, wood, metal, etc. Further, “whiteboard” may include preprinted material, such as a poster, which may be viewed, edited, or otherwise modified by participants.

It is contemplated and to be noted that embodiments are not limited to any particular number and type of powered devices, unpowered objects, software applications, application services, customized settings, etc., or any particular number and type of computing devices, networks, deployment details, etc.; however, for the sake of brevity, clarity, and ease of understanding, throughout this document, references are made to various sensors, cameras, microphones, speakers, display screens, user interfaces, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

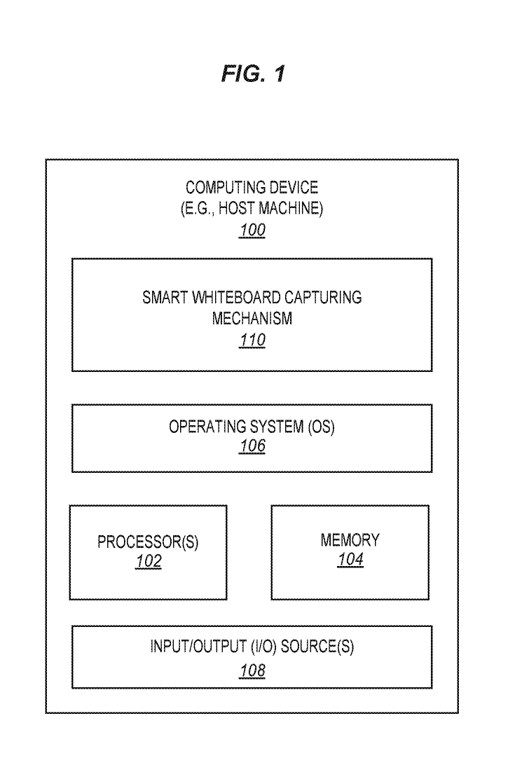

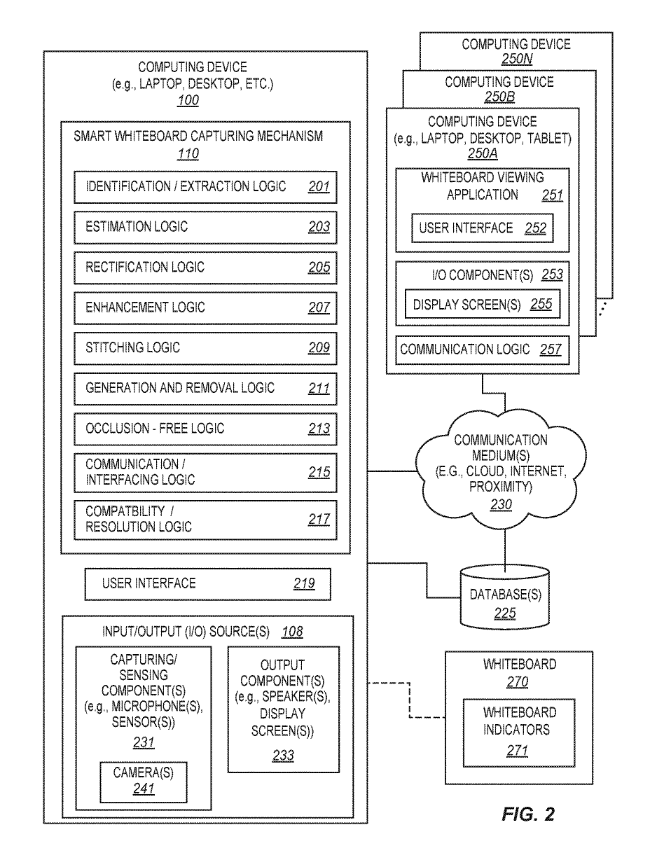

FIG. 1 illustrates a computing device 100 employing a smart whiteboard capturing mechanism (“whiteboard mechanism”) 110 according to one embodiment. Computing device 100 serves as a host machine for hosting whiteboard mechanism 110 that includes any number and type of components, as illustrated in FIG. 2, to facilitate one or more dynamic and automatic measures to offer smart capturing of a whiteboard and its contents regardless of conventional issues (such as inappropriate placement of cameras in the conference room) such that any users (also referred to as “participants”, “attendees”, “viewers”, “persons”, or simply “individuals”) participating through remote conferencing may experience proper and clear viewing of the whiteboard and its contents.

Computing device 100 may include any number and type of data processing and/or communication devices, such as large computing devices (e.g., server computers, desktop computers, etc.) or smaller portable computing devices (e.g., laptop computers, mobile computers, such as tablet computers, smartphones, etc.). Computing device 100 may further include set-top boxes (e.g., Internet-based cable television set-top boxes, etc.), global positioning system (GPS)-based devices, etc. As aforementioned, computing device 100 may include any number and type of mobile computing devices, such as smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, head-mounted binoculars, gaming displays, military headwear, etc.), other wearable devices (e.g., smart watches, bracelets, smartcards, jewelry, clothing items, etc.), Internet of Things (IoT) devices, and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates whiteboard mechanism 110 of FIG. 1 according to one embodiment. In one embodiment, whiteboard mechanism 110 may include any number and type of components, such as (without limitation): identification/extraction logic 201; estimation logic 203; rectification logic 205; enhancement logic 207; stitching logic 209; generation and removal logic 211; occlusion-free logic 213; communication/interfacing logic 215; and compatibility/resolution logic 217.

Computing device 100 is further shown to include user interface 219 (e.g., graphical user interface (GUI)-based user interface, Web browser, cloud-based platform user interface, software application-based user interface, other user or application programming interfaces (APIs) etc.), as facilitated by communication/interfacing logic 215, and I/O source(s) 108 including capturing/sensing component(s) 231 and output component(s) 233.

Computing device 100 is further illustrated as having access to and being in communication with one or more database(s) 225 and/or one or more of other computing devices, such as computing devices 250A, 250B, 250N, over communication medium(s) 230 (e.g., networks such as a cloud network, a proximity network, the Internet, etc.). Further, in one embodiment, whiteboard mechanism 110 may be hosted entirely at and by computing device 100. In another embodiment, one or more components of whiteboard mechanism 110 may be hosted at and by another computing device, such as another computing device in the room or one or more of computing devices 250A-N, etc.

In some embodiments, database(s) 225 may include one or more of storage mediums or devices, repositories, data sources, etc., having any amount and type of information, such as data, metadata, etc., relating to any number and type of applications, such as data and/or metadata relating to one or more computing devices, cameras, whiteboards, mathematical formulae, applicable laws, rules, regulations, policies, user preferences and/or profiles, security and/or authentication data, historical and/or preferred details, and/or the like.

As aforementioned, computing device 100 may host I/O sources 108 including capturing/sensing component(s) 231 and output component(s) 233. In one embodiment, capturing/sensing components 231 may include sensor array (such as microphones or microphone array (e.g., ultrasound microphones), camera(s) 241 including camera array (e.g., two-dimensional (2D) cameras, three-dimensional (3D) cameras, infrared (IR) cameras, depth-sensing cameras, etc.), capacitors, radio components, radar components, etc.), scanners, accelerometers, etc. Similarly, output component(s) 233 may include any number and type of display devices or screens, projectors, speakers, light-emitting diodes (LEDs), one or more speakers and/or vibration motors, etc.

As illustrated, in one embodiment, computing device 100 may be coupled to one or more other computing devices, such as computing device 250A-N, to offer the visuals or the output of whiteboard 270 and its contents as capture and processed by computing device 100 and provided to computing devices 250A-N over one or more communication medium(s) 230. It is contemplated that embodiments are not limited to any particular physical location or distance at which computing devices 250A-N may be located. For example, computing device 250A may be remotely located in user A's office in another country, while computing device 250B may be remotely located in user B's home in the same town, and while computing device 250N may be locally located in the same conference room as computing device 100.

Computing devices 250A-N may host a whiteboard viewing applications, such as whiteboard viewing application (“viewing application”) 251, offering user interfaces, such as user interface 252, for viewing whiteboard 270 and its contents as communicated by computing device 100 over one or more communication medium(s) 230 and as facilitated by communication/interfacing logic 215 of computing device 100 and/or communication logic 257 of computing device 250A. Further, as with computing device 100, each of computing devices 250A-N may host I/O component(s) 253 including one or more of cameras, microphones, speakers, keyboards or keypads, display screens, and/or the like. For example, user A may remotely participate in a meeting by viewing whiteboard 270 and its contents using display screen 255 of I/O component(s) 253 and may further participate in the meeting by speaking through one or more microphones and listening to the proceedings of the meeting through one or more speakers of I/O component(s) 253 of computing device 250A.

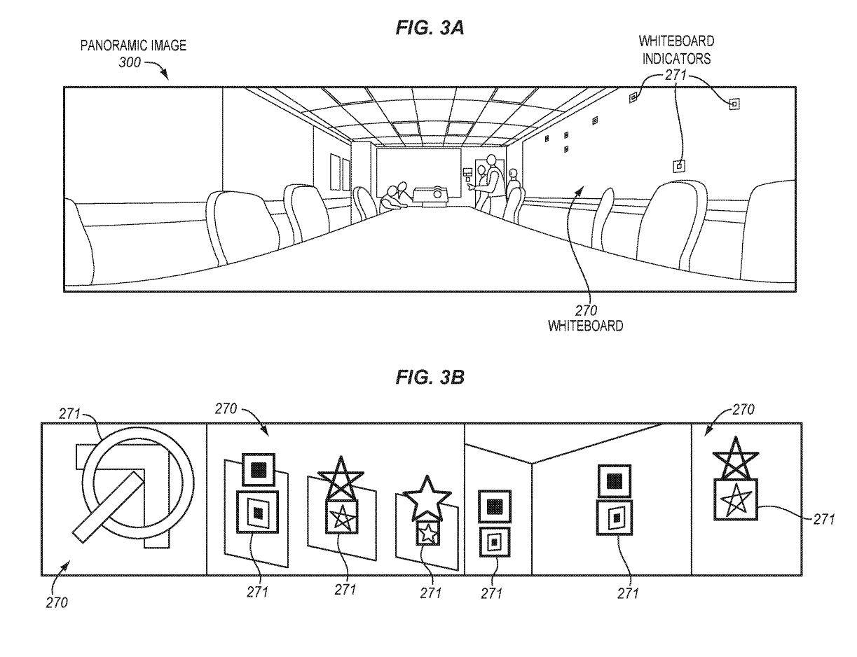

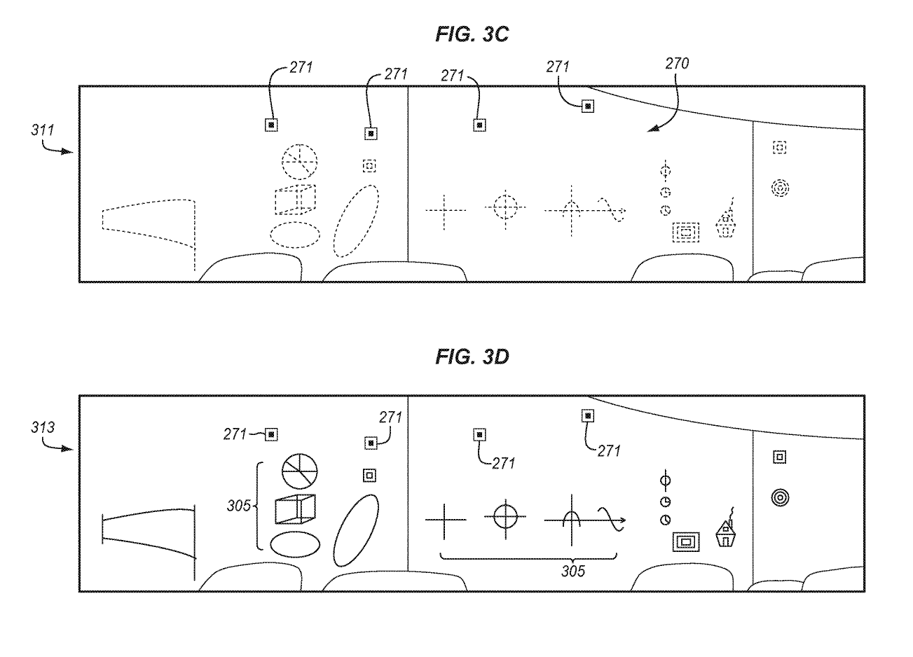

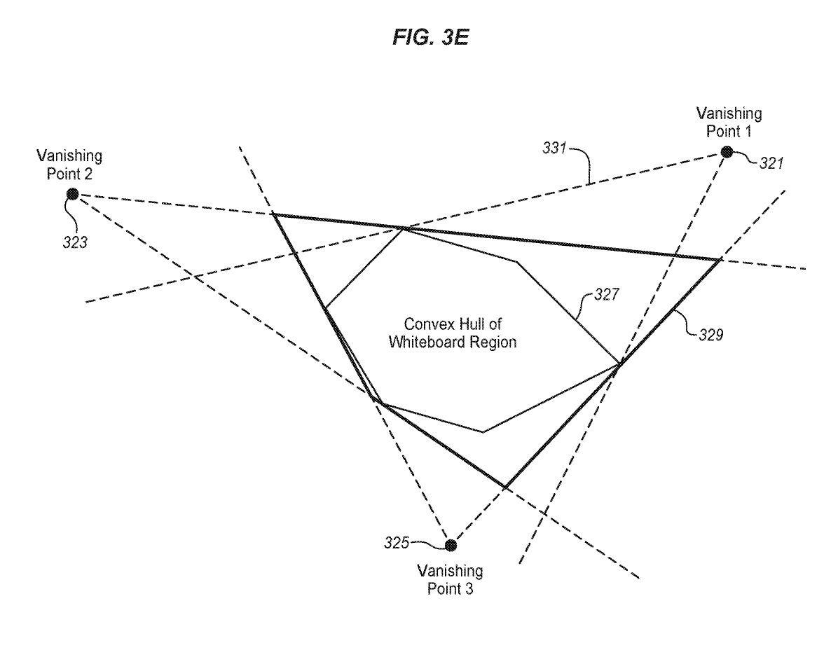

Referring back to whiteboard mechanism 110, as will be further described later in this document, it provides for an automatic detection of whiteboard indicators 271, as further illustrated in FIG. 3A, from an input image as facilitate by one or more of camera(s) 241, where one of whiteboard indicators 271 refers to a pre-defined pattern that is used by a user, such as a user in the conference room, to put on a target whiteboard, such as whiteboard 270, to indicate a particular whiteboard the user wants to share. Further, in one embodiment, using whiteboard mechanism 110, a whiteboard region of whiteboard 270 is grown from the neighborhood of those detected whiteboard indicators 271 by assuming color continuity of the whiteboard surface of whiteboard 270.

In one embodiment, using the input image captured by camera(s) 241, identification/extraction logic 201 may be used to not only detect the whiteboard indicators 271, but also extract edges to more accurately determine the boundaries of whiteboard 270. For example, identification/extraction logic 201 may be used to extract color information from the neighborhood of whiteboard indicators 271, while extraction of still edges is performed using edge accumulation. Color information surrounding whiteboard indicators 271 and extracted edges are used as seeds and termination boundaries, respectively. Using this information, identification/extraction logic 201 may grow the region of whiteboard 270, which leads to extraction of boundary polygons via convex hull and post-removal of irrelevant regions, which finally leads to identification of the whiteboard region.

For example, the boundary of the identified whiteboard region may be refined by finding a minimum-bounding rectangle having edges that are aligned with vanishing lines in the scene captured in the input image, where whiteboard 270 may then be rectified as a frontal-view image by using an aspect ratio that is estimated, as facilitated by estimation logic 203, using the whiteboard indicators 271 on whiteboard 270.

In one embodiment, identification/extraction logic 201 identifies a whiteboard region of whiteboard 270, where the whiteboard region is the region encompassing whiteboard as, for example, a convex polygon as identified from an input image as captured by camera(s) 241 of computing device 100 placed somewhere in the conference room, such as placed on a desk or installed on a wall in the room. It is contemplated that the users in the room may voluntarily or be asked to put whiteboard indicators 271 on whiteboard 270, where whiteboard 270 is the target whiteboard that they wish to share with other remote users, such as the users of computing devices 250A-N.

In one embodiment, multiple whiteboard indicators 271 may be used to cover a wide whiteboard, such as whiteboard 270, that has thin boundary lines between its whiteboard tiles, where the adjacent whiteboard region may be merged together to form a continuous region. Further, multiple indicators of whiteboard indicators 271 may also be used in several spatially isolated whiteboards to identify multiple whiteboard regions for selection by users. Multiple whiteboard indicators 271 may also be placed within the same continuous whiteboard region to provide more accurate estimation of aspect ratio.

Upon identifying the whiteboard region, estimation logic 203 may be triggered to estimate a scene geometry based on the whiteboard region, where the estimate of the scene geometry includes estimation of vanishing lines as each position of the scene being reflected in the whiteboard region. In one embodiment, estimation logic 203 is further used to automatically estimate the aspect ratio of the actual width-to-height ratio of whiteboard 270 from whiteboard indicators 271, while it is contemplated that multiple indicators of whiteboard indicators 271 may also be placed within the same continuous whiteboard region to provide more accurate estimation of aspect ratio. As aspect ratio describes the proportional relationship between the width and the height of an image.

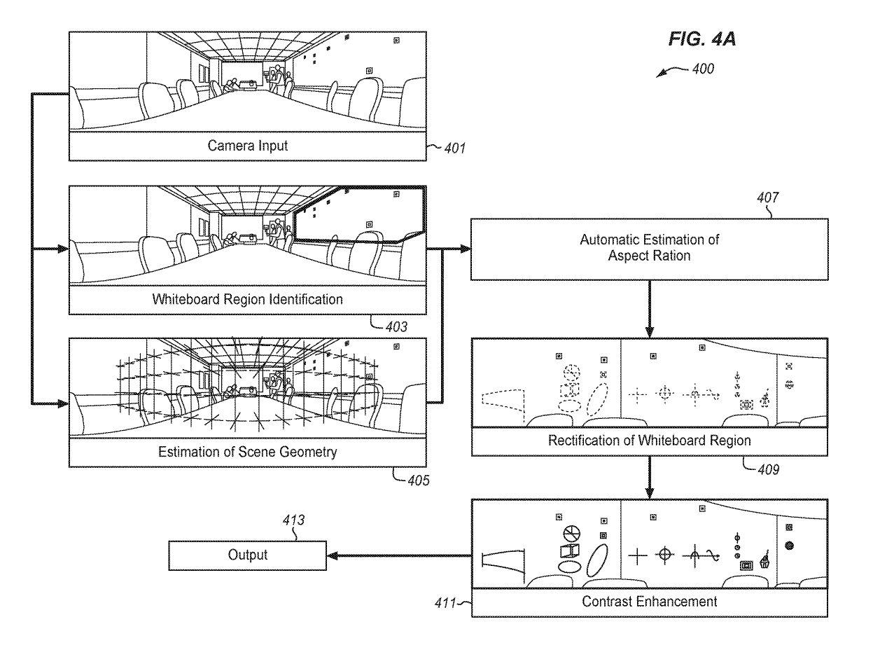

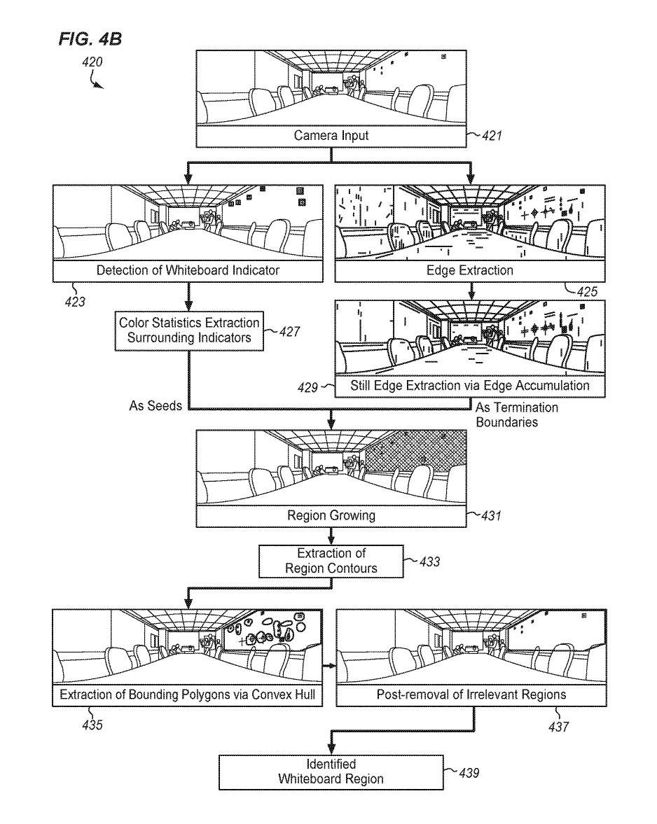

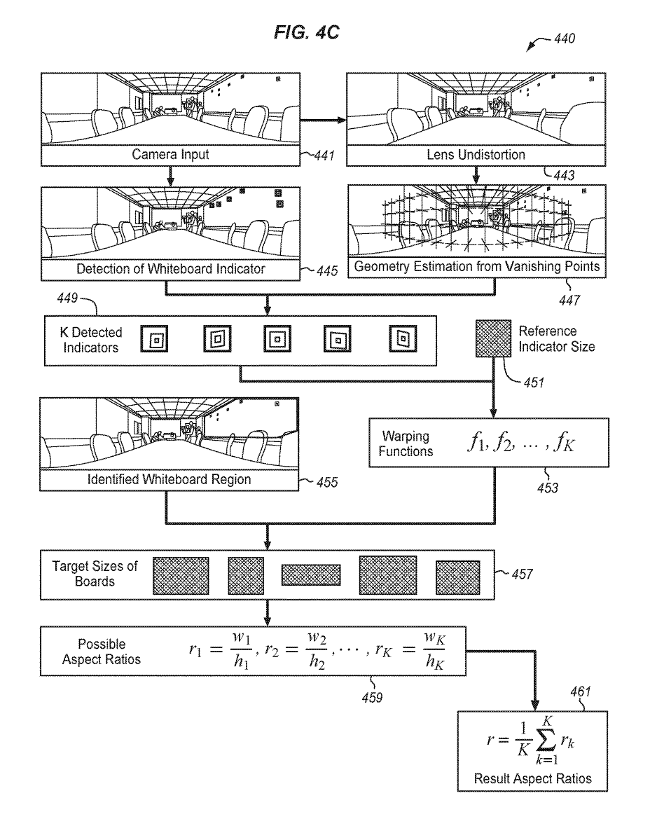

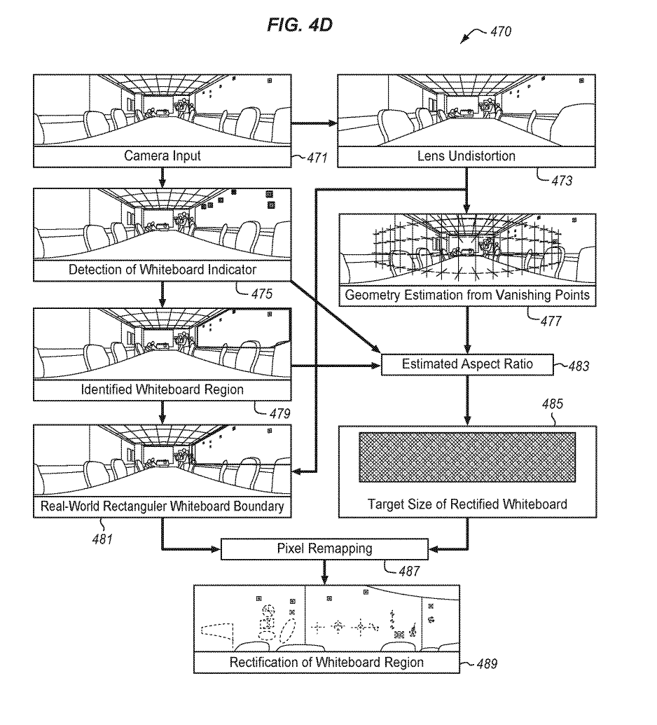

In one embodiment, rectification logic 205 may then be used to rectify the whiteboard image of whiteboard 270 by correcting any geometric distortions of the identified whiteboard region to provide a frontal-view of whiteboard 270. Upon performing rectification, enhancement logic 207 may be used to perform contrast enhancement of whiteboard 270, which improves the quality of the rectified whiteboard image to provide a clearer view of its content. These features are further discussed and illustrated with reference to FIGS. 3A-3C and 4A-4E.

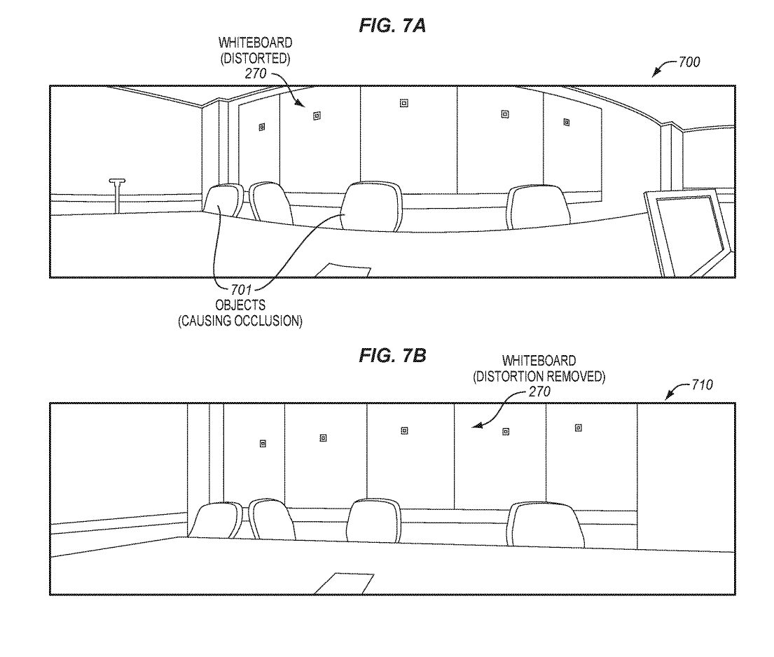

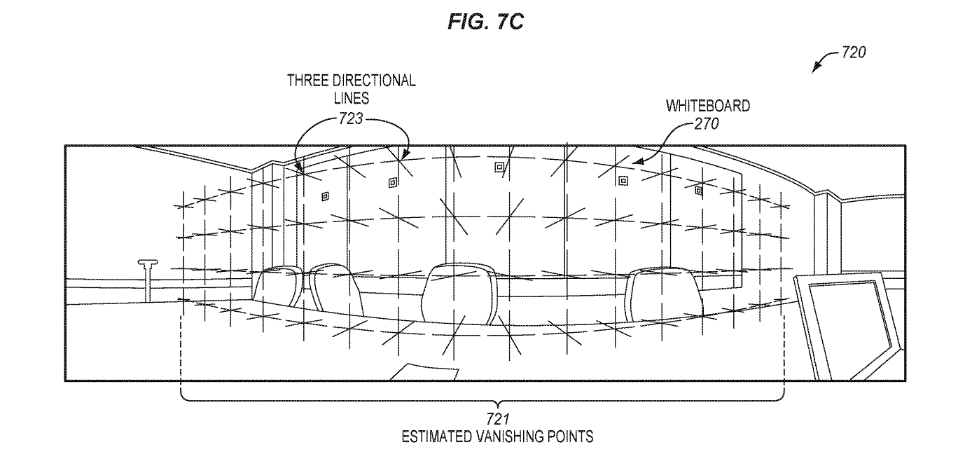

In one embodiment, a panoramic camera of camera(s) 241 may be placed in the room to obtain a wider coverage of the scene as illustrated in FIG. 7A. If the image of whiteboard 270 is severely distorted due to lens distortion and incomplete due to object/individual occlusion and lack of proper camera coverage, generation and removal logic 211 may be triggered to facilitate lens un-distortion to remove any non-linearity of pixel coordinate mapping during whiteboard rectification, identification/extraction logic 201 may be used to facilitate vanishing point detection to utilize vanishing lines to identify horizontal-vertical-depth directions of a scene with several regular-shaped objects to assist in, as facilitated by estimation logic 203, completing the occluded whiteboard boundaries and estimating a correct aspect ratio of the rectified whiteboard.

In one embodiment, estimation logic 203 may be used to estimate vanishing points of the conference room from a stitched image sequence, as facilitated by stitching logic 209, of images captured by the panoramic camera of camera(s) 241, which also includes performing lens un-distortion for stitched panoramic images. For example, the vanishing points of the scene may then be estimated by estimation logic 203 by finding the parallel lines that merge in the same point under the projective geometry. These vanishing points provide the relevant geometrical information regarding the horizontal-vertical-depth directions of the conference room, which can then be used to complete the occluded whiteboard boundaries, and estimate the correct aspect ratio of the rectified whiteboard as facilitated by estimation logic 203.

For example, lens distortion may be corrected by generation and removal logic 211 at each stitched frame of the image sequence captured by the panoramic camera of camera(s) 241 by, as facilitated by stitching logic 209, re-stitching any image patches after lens-wise un-distortion. From these undistorted images, line-segments are extracted from the background objects in the scene, as facilitated by identification/extraction logic 201, by using temporal accumulation of edge masks to remove any noisy edges from any foreground moving objects as facilitated by generation and removal logic 211.

For example, a vanishing point may be detected by grouping line segments that merge at the same point and then by applying project geometry in a distortion-free camera model. In one embodiment, removal of lens-distortion removal from the stitched image may be performed by generation and removal logic 211 and then vanishing points may be estimated from the distortion-free image as facilitated by estimation logic 203.

Further, using a panoramic image stitched from multiple lens, generation and removal logic 211 may be used to generate an undistorted image as if it was captured from a single pin-hole lens, as shown in FIG. 7B. Further, a panoramic camera of camera(s) 241, as facilitated by stitching logic 209, stitches the inputs from multiple lens for an ultra-wide coverage of the scene. It is contemplated that original panoramic stitching may be performed on images from multiple lenses. In one embodiment, stitching logic 209 may be used to perform re-stitching of the panoramic image after having corrected the lens distortion in each individual lens and unifying their viewing directions. This allows for generation of a panoramic and non-distorted image as if it had been taken from a single pinhole lens. For reducing the number of lens to be used, each lens may also be fish-eye lens with severe geometrical distortions, which may necessitate correcting the lens-distortion within each lens to unify the coordinate systems and smooth the inter-lens boundary for a continuous coverage, as facilitated by generation and removal logic 211.

In one embodiment, stitching logic 209 may perform re-stitching after lens-wide un-distortion, which re-applies the necessary rotation in the 3D world coordinate system and re-positions the image patch from each lens in the image coordinate system. Further, in one embodiment, stitching logic 209 stitching images from multiple lenses of one or more camera(s) 241, which is different from merely a single-lens un-distortion. Further, contrary to conventional techniques, stitching images of multiple lenses produces distortion-free results with a unified coordinate system, which is also different from multiple camera calibrations, given the process of re-stitching.

Further, in contrast to still-image based processes, in one embodiment, for vanishing point estimation, image sequences are processed to enable usage of temporal information for more robust analysis by estimation logic 203. For example, estimation logic 203 may estimate the vanishing points by using reliable line segments extracted from temporally accumulated edge mask, which removes the noisy edges from moving foreground objects. For example, these estimated vanishing points are illustrated in FIG. 7C, where the three lines with different shades may represent the horizontal-vertical-depth directions of the coordinated system at that particular pixel position.

Further, for example, parallel lines may merge at the same vanishing point under projective geometry, such as in man-made scenarios with many regular-shaped objects, several of the lines may be well-aligned with three orthogonal axis, such as horizontal, vertical, and depth direction of the scene. For example, detection of the vanishing points for these directions, as facilitated by identification/extraction logic 201, may offer the necessary information to realize and comprehend the geometry of the scene.

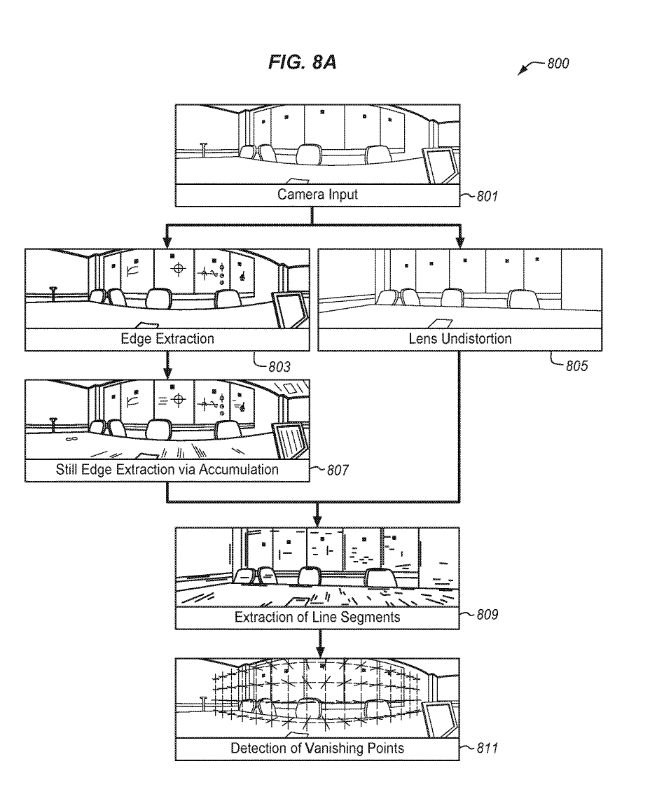

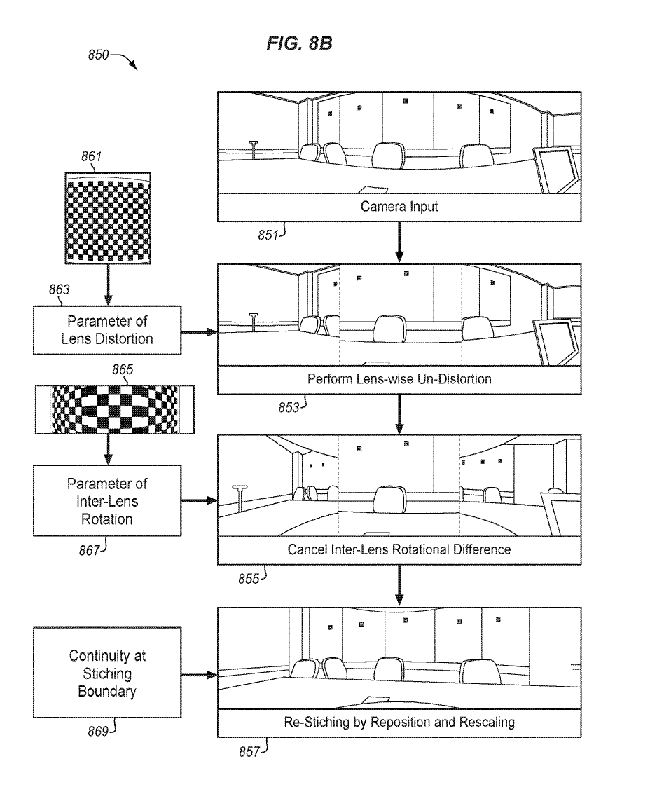

This process for extracting vanishing points from a sequence of stitched panoramic images, as facilitated by identification/extraction logic 201, is depicted in FIG. 8A. As will be illustrated with respect to FIG. 8A, lens distortion of the stitched image is corrected and a mask of edge pixels is computed from the background objects by suppressing those edges from the foreground objects as facilitated by generation and removal logic 211. Then, the edge mask is projected into the undistorted image, while line segments are extracted and by analyzing the line segments, vanishing points are detected in the conference room as facilitated by identification/extraction logic 201.

Further, in one embodiment, using identification/extraction logic 201, line segments may be extracted from still scene objects for a reliable estimation of vanishing points by estimation logic 203. For example, still edges may be extracted from an image by extracting the edge mask by an edge detector and accumulating the edge mask over time, where this is useful in removing any changing edges from moving the foreground objects as facilitated by generation and removal logic 211. Further, for each edge pixel in the still edge mask, its coordinates may be converted into an undistorted image, while its line segments are extracted by identification/extraction logic 201. For example, a line segment detector may be utilized.

Referring back to detection or identification of vanishing points, an optimal value of vanishing points may be searched to then randomly select multiple subsets of line segments to form a hypothesis of the vanishing points, where this hypothesis is then validated with all other line-segments. In some embodiments, the hypothesis with the highest support is accepted as a final result. For example, at the first frame of an image sequence, a complete estimation is performed by sampling any number of hypothesis (e.g., 2000 hypothesis), as facilitated by estimation logic 203. The result of this estimation may then be used to initialize the estimation in the following frames, such as where an incremental validation with a number of samples (e.g., 500 samples) is performed at each frame to check the acceptability of the present optimal vanishing points. In some embodiments, vanishing points allow for checking of any alignments of the line-segments so as to assist in identifying and completing the boundary of a whiteboard. This process also enables computing a projection matrix of camera(s) 241, which may then be used in both homograph-based pixel remapping and automatic estimation of the aspect ratio in whiteboard rectification.

To provide a clear view of the whiteboard contents to the users of computing devices 250A-N, an occlusion-free view of whiteboard 270 is achieved, even when using low-cost cameras of camera(s) 241 that are presently available for video conferencing. In one embodiment, occlusion-free logic 213 may be used to identify one or more foreground objects (e.g., occluding objects) from the background (e.g., whiteboard region) to present an occlusion-free whiteboard region for the viewers having access to one or more of computing device 250A-N.

In one embodiment, occlusion-free logic 213 may be used to identify foreground objects and replace them with the background pixels from history. For example, any edges belonging to the foreground objects are noisy and may not appear at the same pixel location over a certain period of time (such as an edge detection threshold) and thus, these edges may be identified and any edges that remain constant as background edges are classified as such, while any remaining edges are classified as foreground edges as facilitated by occlusion-free logic 213. Further, these foreground edge pixels in the current frame may then be replaced with the pixels from history, while the resulting frame represents the most recently visible version of each portion of whiteboard 270.

It is contemplated that occlusion-free logic 213 may be used for occlusion removal to differentiate the foreground with any background objects. Further, occlusion-free logic 213 is capable of working with any type of camera or camera(s) 241 and does not require any training or prior knowledge of the background as it is capable of working in different environments.

In some embodiments, the starting assumptions may include camera(s) 241 may not be moving, foreground edges may move at least once within edge detection threshold frames, where an edge detection threshold value is a set constant, such as a pixel edge to remain at the same location for a number of frames (e.g., 70 frames, etc.) to be considered a background pixel.

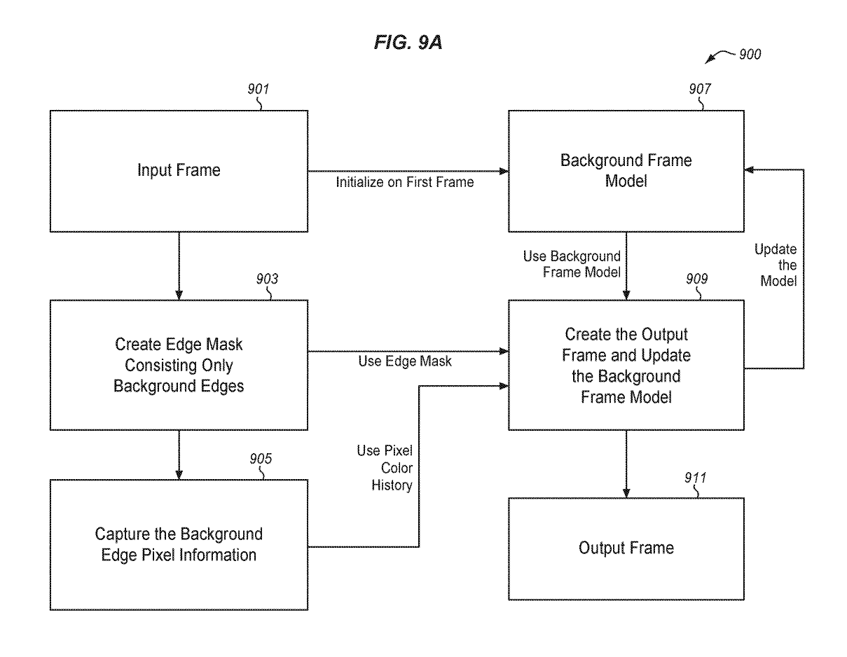

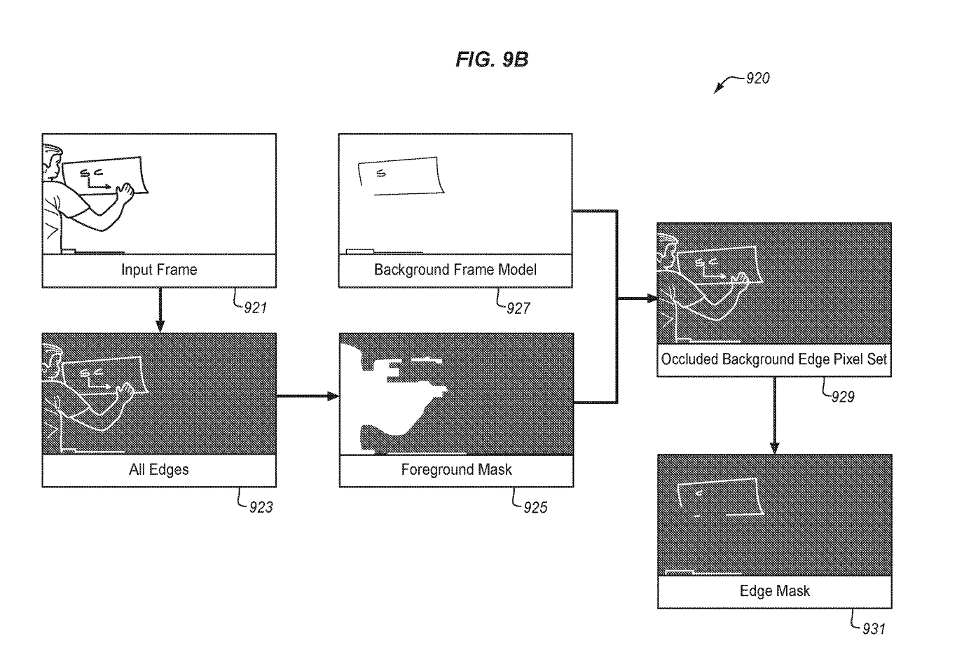

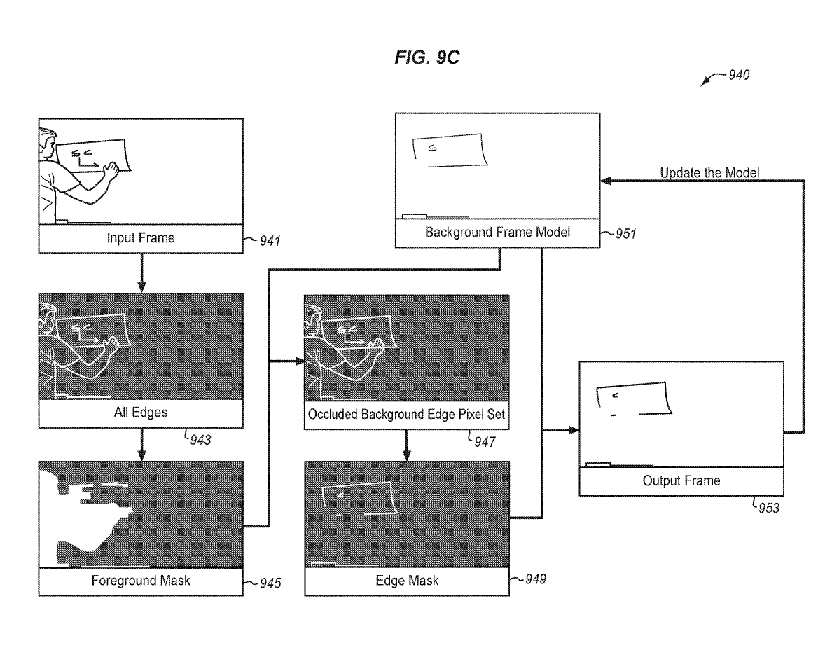

With regard to creation of an edge mask, in one embodiment, as illustrated with reference to FIG. 9A, occlusion-free logic 213 may be used to detect edges in a given frame and increment the age counter for pixels relating to the edges, where each pixel has a counter and a value of all pixels that are part of these edges is incremented. In one embodiment, occlusion-free logic 213 is further used to determine any background edges and classify as background edges those edges that appear at the same pixel location for the length of an edge detection threshold value. Further, in one embodiment, occlusion-free logic 213 to handle any missing background edges, such as if an edge that was previously classified as a background edge is missing in a current frame then it may either be 1) occluded by a foreground object or 2) erased by the user. The edges that are occluded by the foreground object may then be identified and set in an edge mask.

In one embodiment, to handle any background edges being occluded by the foreground object the following processes may be performed: 1) remove any background edges in the current edge mask; 2) extract the contour of the region formed by the remaining edges as the foreground mask; and 3) set the background pixels that are missing in the current frame and are also part of the foreground mask. For example, if the missing background edge is part of a foreground mask then the assumption is made that it is being occluded and not erased by the user. It is contemplated that for any edges that are set in the above process, the age counter is not incremented, where the age counter is reset to 0 for all the pixels that do not have an edge set in the current frame.

Further, in one embodiment, occlusion-free logic 213 may be further used to clear the edges from the edge mask whose age counter is less than the threshold value. This way, the edge mask has all the background edges set (including those edges that may be occluded by any foreground objects).

With regard to capturing of background edge pixel information, a lookup table of pixel history is built for those edges that are determined or classified as background edges in a current frame. These edges may be presumed to be new writing on whiteboard 270 and also any other objects that are part of whiteboard 270. Once a pixel age counter has crossed the threshold value, occlusion-free logic 213 may capture the pixel value from the current frame into a pixel color history, where this information may then be used to set the background edges in a final output frame.

Further, as illustrated with respect to FIG. 9B, a background frame model may be used to replace the foreground pixels in the current frame. This model may be initialized with the first frame and then on every frame update with the output frame. This background frame model may represent an occlusion-free frame as seen by one or more users at one or more of computing devices 250A-N.

In one embodiment, occlusion-free logic 213 assists in generation of an occlusion-free output frame of the image of whiteboard 270 and its contents by initializing the existing output frame with zeros. Using the edge mask and pixel color history, the output frame may be filled with the background edge pixels, where for the pixels in the edge mask, a corresponding value in the pixel color history is looked up and set in the output frame. Any remaining pixels are then filled with pixels from the background frame model. For the background edges that are missing in the edge mask, the pixels are replaced with the pixels from the current frame. For example, if a previously classified background edge is missing from the current edge mask then this edge may have been erased by the user, while the pixel information from the current frame may have been used instead of the background frame model. The background model is then updated with the output frame, which is then returned and offered to one or more computing devices 250A-N over one or more communication medium(s) 230 for viewing by their users.

It is contemplated that the color and/or intensity difference between the unclear contents and the whiteboard background may be small under both bright and dark lighting conditions. Further, any improvements of those contents may be resolved with a strong enhancement of their contrast, which could otherwise lead to noisy artifacts. Embodiments provide for enhancement logic 207 to facilitate contrast enhancement for a rectified whiteboard image from a panoramic camera of camera(s) 241 so that the whiteboard contents may be clearly viewed and shared with more meeting participants under various lighting conditions. This enhancement may also be useful with local attendees present in the room when, for example, the contents of whiteboard 270 may be hard to view from a particular angle and/or under poor lighting conditions.

Considering the color continuity of the background of whiteboard 270, in one embodiment, enhancement logic 207 may be used to identify and enhance the unclear contents of whiteboard 270 with less noises, such as by designing an adaptive enhancement function of the contrast. This adaptive enhancement function may perform the strong enhancement on the whiteboard contents while suppressing the noisy artifacts in the background of whiteboard 270, as facilitated by enhancement logic 207.

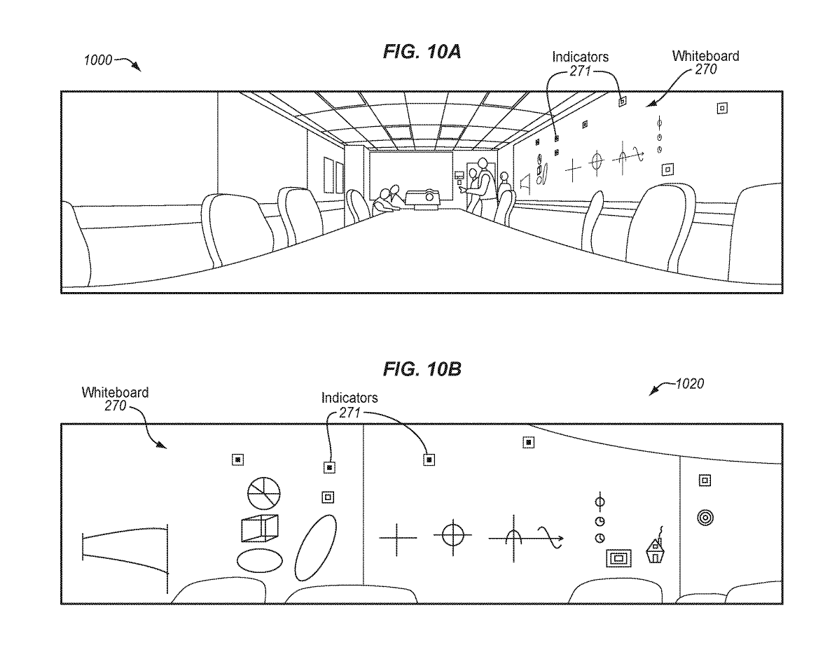

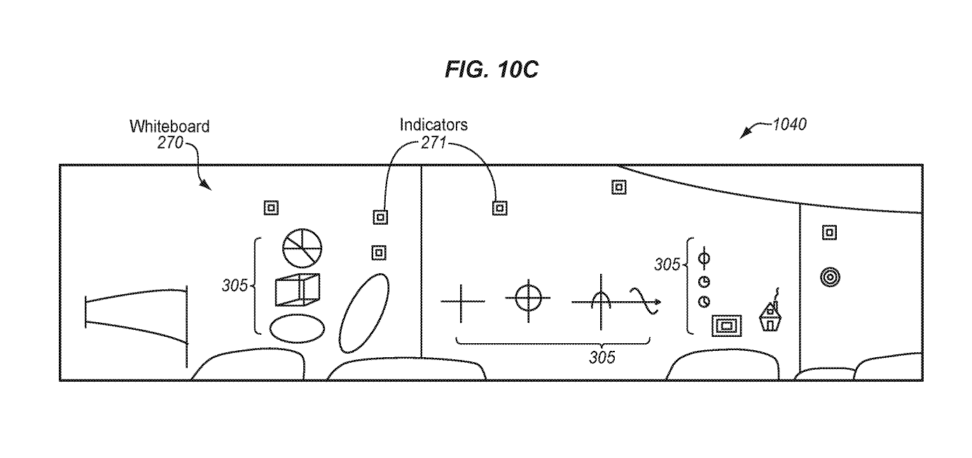

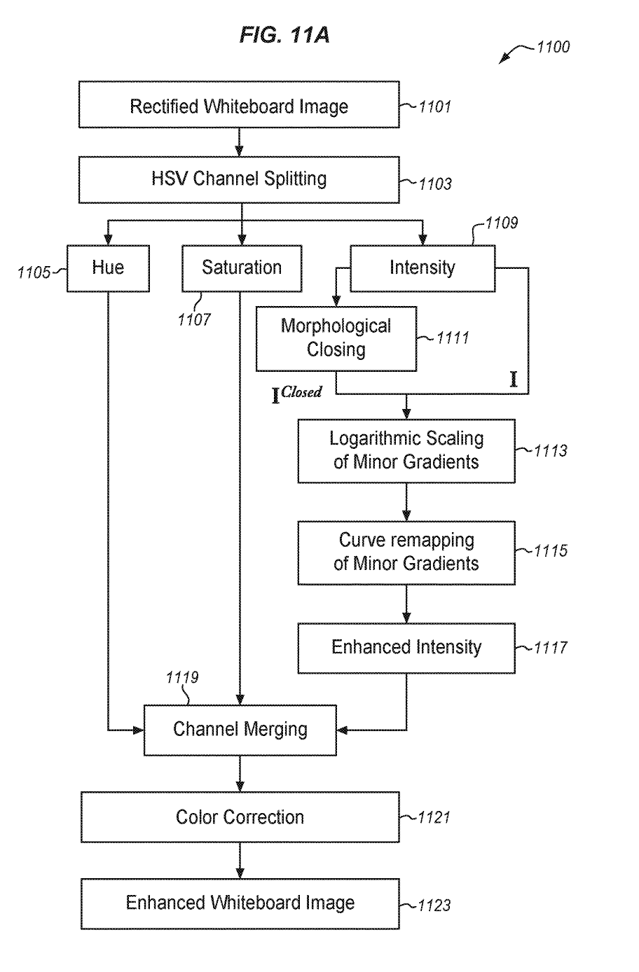

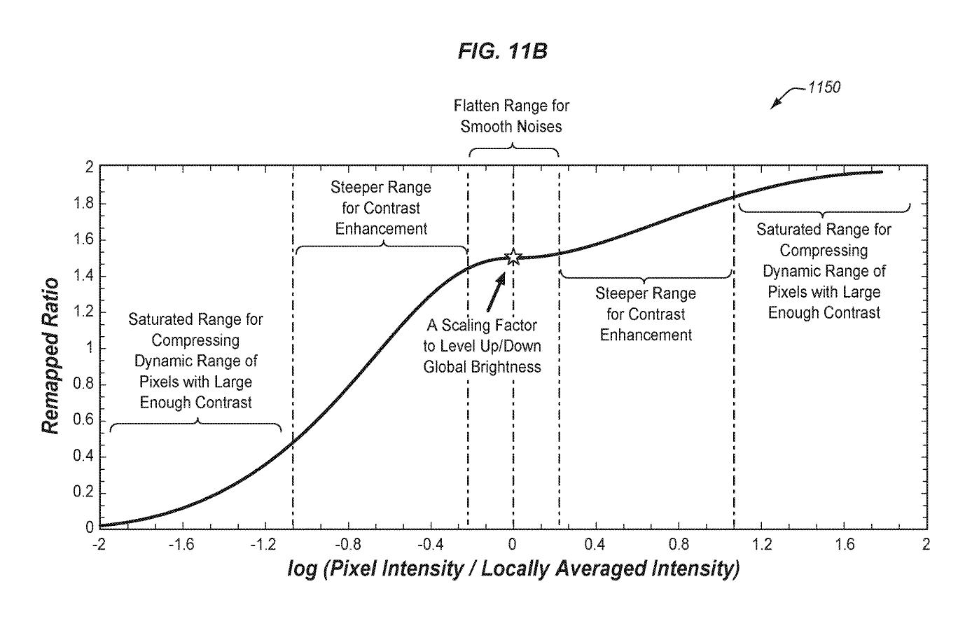

As illustrated with reference to FIGS. 10A, 10B and 10C, enhancement logic 207 provides for contrast enhancement that performs pixel-wise enhancement to avoid any block artifacts. Given the homogeneous background color of whiteboard 270, enhancement logic 207 may use the ratio between the pixel intensity and its locally averaged value as the clue for adaptively determining the level of enhancement. This ratio may be first logarithmically scaled to magnify the difference caused by the whiteboard contents of whiteboard 270. Further, in one embodiment, a novel function may be used by enhancement logic 207 to adaptively map the pixel value from the input image to its enhanced output such that to smooth minor noises, enhance medium gradients, and compress any dynamic range for large gradients, etc., as illustrated with reference to FIG. 10C. As further illustrated with reference to FIG. 11A, in one embodiment, enhancement logic 207 may be triggered to process a rectified whiteboard image of whiteboard 270, as obtained using rectification logic 205, to achieve an enhanced whiteboard image of whiteboard 270.

Capturing/sensing components 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 may include (without limitations): audio/visual devices (e.g., camera(s) 241, microphones, speakers, etc.); context-aware sensors (e.g., temperature sensors, facial expression and feature measurement sensors working with one or more camera(s) 241 of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Capturing/sensing component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios, architectural placements, or component setups; however, for the sake of brevity and clarity, illustrations and descriptions with respect FIGS. 3B-3C are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/interfacing logic 215 may be used to ensure a continuous communication between one or more of computing device 100, computing devices 250A-N, database(s) 225, communication medium(s) 230, whiteboard indicators 271 of whiteboard 270, etc. Further, communication/interfacing logic 215 may be used to offer user interface 219, user interface 252, and/or, and/or facilitate communication through user interfaces 219, 252, etc., and/or similar user interfaces or other application programming interfaces (APIs).

Compatibility/resolution logic 217 may be used to facilitate dynamic compatibility and conflict resolution between various components, networks, computing devices, etc., such as computing device 100, computing devices 250A-N, database(s) 225, communication medium(s) 230, whiteboard indicators 271 of whiteboard 270, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as camera(s), etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “whiteboard”, “whiteboard indicator”, “capturing”, “rendering”, “rectification”, “content enhancement”, “occlusion”, “occlusion-free”, “clear view”, “whiteboard contents”, “panoramic image”, “user interface”, “panoramic camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “Internet of Things”, “IoT device”, “proximity network”, “cloud network”, “server computer”, etc., should not be read to limit embodiments to software or devices that carry that label in products or in literature external to this document.

It is contemplated that any number and type of components may be added to and/or removed from whiteboard mechanism 110 to facilitate various embodiments including adding, removing, and/or enhancing certain features. For brevity, clarity, and ease of understanding of whiteboard mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a panoramic image 300 of a conference room according to one embodiment. As an initial matter, for brevity, many of the details discussed with reference to the previous FIGS. 1-2 may not be discussed or repeated hereafter. In the illustrated embodiment, panoramic image 300 of a conference room is shown, where this panoramic image 300 may be captured by a camera, such as camera(s) 241 of FIG. 2, which may be part of or in communication with a computing device, such as computing device 100 of FIG. 2, placed in the conference room. For example, a camera, such as camera(s) 241 of FIG. 2, may be placed in the conference room to provide panoramic view 300 of the scene, which enables remote users, such as users of computing devices 250A-N of FIG. 2, to focus on local attendees, view whiteboard 270, or other object of interest, etc., through whiteboard identification and rectification as described with reference to FIG. 2.

As illustrated, a typical conference room may be cluttered with individuals as well as several objects, such as telephones, chairs, tables, pictures, windows, etc., but also with many whiteboard-alike objects, such as a noticeboard, etc., which may cause the shape of whiteboard 270 to be severely skewed or shown incomplete in the input image, being represented here by panoramic image 300, due to any number of reasons, such as object occlusion, lens distortion, camera placement, projective geometry, etc.

As previously described with reference to FIG. 2, whiteboard 270 may be detected from panoramic image 300 and then rectified by finding its edges (which may or may not be captured, such as the top-right corner/edge of whiteboard 270 missing from panoramic image 300) to provide a distortion-free frontal-view image of whiteboard 270 when viewed at one or more of computing devices 250A-N without being occluded by individuals or other objects in the room.

FIG. 3B illustrates whiteboard indicators 271 according to one embodiment. As an initial matter, for brevity, many of the details discussed with reference to the previous FIGS. 1-3A may not be discussed or repeated hereafter. In one embodiment, specific patterns, such as whiteboard indicators 271, are introduced to solve any ambiguity in identifying surfaces that the user wishes to share in any number of complicated scenarios, such as in case of images having incomplete and severely skewed whiteboards. In one embodiment, these whiteboard indicators 271 may be of any design or geometry (such as squares, triangles, circles, stars, crescents, etc.), oriented or non-oriented, hand-drawn (such as by the users in the room), printed (such as professionally printed at the time of manufacturing or thereafter), etc., on the surface of whiteboard 270 which is to be shared as a target whiteboard.

FIG. 3C illustrates a resultant rectified image 311 of a whiteboard 270 that is identified and rectified, while FIG. 3D illustrates a contrast enhanced output 313 representing a final result of the whiteboard 270 according to one embodiment. As an initial matter, for brevity, many of the details discussed with reference to the previous FIGS. 1-3B may not be discussed or repeated hereafter. In FIG. 3C, resultant rectified image 311, as facilitated by rectification logic 205 of FIG. 2, is shown to have whiteboard indicators 271. In FIG. 3D, contrast enhanced output 313, as facilitated by enhancement logic 207, is shown to have enhanced contents 305 along with whiteboard indicators 271. Given the neighboring pixels of whiteboard indicators 271, color information as well as edge information relating to whiteboard 270 may be estimated by assuming color continuity over the surface of whiteboard 270. In one embodiment, a region-growing technique may be used by identification/extraction logic 201 of FIG. 2 to assume the identification of whiteboard 270, which enables handling whiteboards with severe geometrical distortion and object occlusion, such as those caught in a wide-angle image with strong lens distortion.

Further, for example, whiteboard indicators 271 may be used by estimation logic 203 of FIG. 2 to automatically estimate the aspect ratio of the rectified whiteboard, which is particularly useful when an accurate camera calibration might not be available. Further, reliable edges are extracted from the background objects by using temporal accumulation to improve both the whiteboard boundary determination and vanishing point estimation to enable processing of live images or video sequences occurring in a live conference/meeting being taken place in the conference room. In one embodiment, resultant rectified image 311 of whiteboard 270 of FIG. 3C, as facilitated by rectification logic 205 of FIG. 2, is further processed to obtain contrast enhanced output 313 of whiteboard 270 of FIG. 3D, as facilitated by enhancement logic 207 of FIG. 2, where this output 313 may be regarded as a final image or sequence of images that is then communicated on to one or more computing devices 250A-N over one or more communication medium(s) 230.

FIG. 3E illustrates a whiteboard rectification technique 320 for correcting geometrical distortions to provide a frontal and clear view of whiteboard contents of a whiteboard according to one embodiment. As an initial matter, for brevity, many of the details discussed with reference to the previous FIGS. 1-3D may not be discussed or repeated hereafter. It is contemplated that due to occlusion and incomplete camera coverage, convex hull 327 obtained from whiteboard identification may also be incomplete as the boundaries of the whiteboard. Since the whiteboard is typically aligned with vanishing lines in the scene, in one embodiment, these vanishing lines, meeting at vanishing points 321, 323, 325, that form minimum-rectangular boundary of the whiteboard from its convex hull 327 are found. In one embodiment, a pair of vanishing points, such as those of vanishing points 321, 323, 325, is searched, where this pair forms rectangle 329 to fully contain convex hull 327 with the minimum area, where these two vanishing points are selected as a subset from the three detected vanishing points and test the rectangle, rectangle 329, it forms as one hypothesis of the target whiteboard boundary. Further, these vanishing line forming the minimum-bounding rectangle 329 pass through a vertex of convex hull 327. In one embodiment, the searching space is reduced by considering merely two vanishing lines at each vanishing point 321, 323, 325 that pass through the vertices of convex hull 327 with the largest spanning angle.

Given the estimated vanishing points and the identified minimum-bounding rectangle 329, in one embodiment, geometrical pixel mapping is performed between the identified whiteboard region and its rectified shape with automatically estimated aspect ratio as further illustrated in FIG. 4D.

FIG. 4A illustrates a method 400 for facilitating whiteboard identification and rectification according to one embodiment. Method 400 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3E may not be discussed or repeated hereafter.

Method 400 begins at block 401 with receiving and analyzing of a camera input, which includes a panoramic image of a whiteboard in a room, where the image is captured by a camera of a computing device placed in the room. At block 403, whiteboard region identification and region growing is performed to identify the region of the whiteboard as a convex polygon. At block 405, a scene geometry is estimated using the whiteboard region identification. At block 407, using the region identification and scene geometry, the aspect ratio is automatically estimated. At block 409, whiteboard region is rectified in a resultant rectified image and subsequently, at block 411, a contrast enhanced output is produced, where, at block 413, the output is then communicated over to one or more client computing devices over one or more communication mediums, such as one or more networks.

FIG. 4B illustrates a method 420 for facilitating whiteboard identification according to one embodiment. Method 420 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 420 are illustrated in linear sequences for brevity and clarity in presentation; however, it is contemplated that any number of them can be performed in parallel, asynchronously, or in different orders. For brevity, many of the details discussed with reference to the previous FIGS. 1-4A may not be discussed or repeated hereafter.

In one embodiment, edge marks are accumulated over time, while the edge pixels are taken into account as they have been existing for a certain period of time. Noisy edges from moving objects may not appear at the same pixel location, which may be then be removed from the edge mask. As illustrated here, the accumulated mask may be much cleaner than the original edge mask, while the boundary of the whiteboard is well preserved. In one embodiment, a contour of the region may be extracted and its minimum-bounding convex hull may be computed or estimated. A post-filtering process may then be used to remove noisy small convex hulls and merge the overlapping convex hulls, while after the post-filtering process, each convex hull represents one whiteboard in the scene. It is contemplated that embodiments are not limited to a single whiteboard and that multiple whiteboards in the room may be used in the scene.

Method 420 begins at block 421 with receiving and analyzing of a camera input, which includes a panoramic image of a whiteboard in a room, where the image is captured by a camera of a computing device placed in the room. At block 423, whiteboard indicators are detected and, at block 425, edges of the whiteboard are extracted. At block 427, using the whiteboard indicators, color statistics of the whiteboard indicators are extracted, while, at block 429, still edges are extracted using edge accumulation based on edge extraction.

In one embodiment, using the color statistics as seeds and still edge extraction as termination boundaries, a growing region of the whiteboard is estimated at block 431 as facilitated by estimation logic 203 of FIG. 2, where estimation logic 203 may be further used to estimate or extract region contours from the growing region at block 433. Similarly, in one embodiment, using the region counters, bounding polygons may be extracted using a convex hull at block 435 and subsequently, any irrelevant regions may be removed at block 437. At block 439, the whiteboard region is identified.

FIG. 4C illustrates a method 440 for facilitating automatic estimation of aspect ratio according to one embodiment. Method 440 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 440 are illustrated in linear sequences for brevity and clarity in presentation; however, it is contemplated that any number of them can be performed in parallel, asynchronously, or in different orders. For brevity, many of the details discussed with reference to the previous FIGS. 1-4B may not be discussed or repeated hereafter.

In one embodiment, a correct aspect ratio of the rectified whiteboard image may be used for whiteboard rectification to present a clear view of the whiteboard and its contents. In one embodiment, this aspect ratio is automatically estimated by using the whiteboard indicators as illustrated here, which may be robust when accurate lens un-distortion may not be available. For example, knowing the design of each whiteboard indicator, a mapping function may be built between each whiteboard indicator and its referential shape. Using this information, in one embodiment, the whiteboard region may be estimated or predicted with a mapping function of each individual whiteboard indicator, while the aspect ratio of the projected shape may be computed or estimated as facilitated by estimation logic 203 of FIG. 2. These aspect ratios from different whiteboard indicators may then be averaged to obtain a final aspect ratio of the whiteboard.

Method 440 begins at block 441 with receiving and analyzing of a camera input, which includes a panoramic image of a whiteboard in a room, where the image is captured by a camera of a computing device placed in the room, while, at block 443, lens distortion is determined. At block 445, whiteboard indicators are detected, while, at block 447, geometry estimation is obtained based on vanishing points. At block 449, whiteboard indicators are detected and subsequently, at block 451, a reference size of the whiteboard indicators is obtained, which is then used in warping functions at block 453.

In one embodiment, at block 455, a whiteboard region is identified, which is then used to obtain target sizes of whiteboards at block 457. This information is then used to obtain possible aspect ratios at block 459, leading to obtaining a final aspect ratio at block 461.

FIG. 4D illustrates a method 470 for facilitating whiteboard rectification according to one embodiment. Method 470 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 470 are illustrated in linear sequences for brevity and clarity in presentation; however, it is contemplated that any number of them can be performed in parallel, asynchronously, or in different orders. For brevity, many of the details discussed with reference to the previous FIGS. 1-4C may not be discussed or repeated hereafter.

In one embodiment, a lookup table of pixel mapping may be built and used to accelerate the process of whiteboard rectification as illustrated here. Method 470 begins at block 471 with receiving and analyzing of a camera input, which includes a panoramic image of a whiteboard in a room, where the image is captured by a camera of a computing device placed in the room. Method 470 may continue with detection of lens un-distortion at block 473 and whiteboard indicators at block 475. Method 470 may continue with geometry estimation being obtained from vanishing points at block 477. Similarly, method 470 may continue at block 479 with identification of a whiteboard and subsequently, at block 481, with estimation of a real-world rectangular whiteboard boundary of the whiteboard.

In one embodiment, results of one or more of the aforementioned processes, such as the geometry estimation, the whiteboard indicators, the whiteboard region, etc., may then be used to estimate an aspect ratio at block 483, while using the aspect ratio, a target size of a rectified whiteboard may be estimated at block 485. In one embodiment, based on the target size of the rectified whiteboard and the real-world rectangular whiteboard boundary, pixel mapping may be performed or estimated at block 487. At block 489, rectification of the whiteboard may then be performed using the pixel mapping.

FIG. 7A illustrates an input panoramic image 700 showing a severely distorted view of a whiteboard 270 according to one embodiment. As an initial matter, for brevity, many of the details discussed with reference to the previous FIGS. 1-4D may not be discussed or repeated hereafter. In one embodiment, panoramic image 700 may be captured using a panoramic camera of one or more camera(s) 241 of computing device 100 of FIG. 2, where this panoramic camera may be placed in the same room as whiteboard 270. As illustrated, in this panoramic image 700, whiteboard 270 is shown as severely distorted due to lens distortion and remains incomplete due to object occlusion and camera coverage. In this illustration, a projector and a number of chairs are shown as objects 701 causing occlusion of whiteboard 270.

FIG. 7B illustrates a panoramic image 710 showing removal of distortion from a view of a whiteboard 270 according to one embodiment. As an initial matter, for brevity, many of the details discussed with reference to the previous FIGS. 1-7A may not be discussed or repeated hereafter. In one embodiment, a panoramic stitching of images from multiple lenses is performed to generate a stitched panoramic image representing an undistorted image as if it was captured from a single pin-hole lens, as illustrated here in panoramic image 710, which includes a distortion-removed image of whiteboard 270.

FIG. 7C illustrates an input panoramic image 720 showing estimated vanishing points 721 relating to a whiteboard 270 according to one embodiment. As an initial matter, for brevity, many of the details discussed with reference to the previous FIGS. 1-7B may not be discussed or repeated hereafter. In the illustrated embodiment, estimated vanishing points 721 are shown all over whiteboard 270 formed by a number of three lines, such as three lines 723, where, in some embodiments, three lines with different shades or color may be used to represent the horizontal-vertical-depth directions of the coordinated system at that particular pixel position.

FIG. 8A illustrates a method 800 for facilitating vanishing points extraction from a stitched image according to one embodiment. Method 800 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 800 are illustrated in linear sequences for brevity and clarity in presentation; however, it is contemplated that any number of them can be performed in parallel, asynchronously, or in different orders.

For brevity, many of the details discussed with reference to the previous FIGS. 1-7C may not be discussed or repeated hereafter.

Method 800 begins at block 801 with receiving and analyzing of a camera input, which includes a panoramic image of a whiteboard in a room, where the image is captured by a camera of a computing device placed in the room. Using the input panoramic image, in one embodiment, edge extraction and lens un-distortion are produced at blocks 803 and 805, respectively. Further, at block 807, using the edge extraction, still edge extraction is performed via accumulation. At block 809, using the still edge extraction and lens un-distortion, line segments are extracted, such as different shades may be used to present inlier line segments of horizontal, vertical, and depth directions of the scene. At block 811, in one embodiment, the vanishing points are detected or identified from the stitched panoramic image.

FIG. 8B illustrates a method 850 for facilitating correction of lens-distortion in a stitched image according to one embodiment. Method 850 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 850 are illustrated in linear sequences for brevity and clarity in presentation; however, it is contemplated that any number of them can be performed in parallel, asynchronously, or in different orders. For brevity, many of the details discussed with reference to the previous FIGS. 1-8A may not be discussed or repeated hereafter.

Method 850 begins at block 851 with receiving and analyzing of a camera input, which includes a panoramic image of a whiteboard in a room, where the image is captured by a camera of a computing device placed in the room. At block 853, in one embodiment, lens-wise un-distortion is performed to correct the distortion in each individual lens. For example, a pattern, such as chessboard pattern 861, may be placed in front of each individual lens, while its corresponding image patch may be cropped. By computing the displacement between chessboard pattern 861 in this image patch and its referential size, a parameter, such as parameter of lens distortion 863, is obtained which may be regarded as the intrinsic parameter Aₘ for the m^{th} lens.

In one embodiment, method 850 continues with correction or cancellation of inter-lens rotational difference at block 855. In one embodiment, a stitching technique may be used to revise the rotational relationship among lenses, which may be used to correct this inter-lens rotation back as if they were taken with a single-lens camera. In one embodiment, a long pattern, such as a long chessboard pattern 865, that covers over all lens of the panoramic camera is put to use to estimate parameter of inter-lens rotation 867, such as the inter-lens rotation matrix R^{mn} between lens m and n by using chessboard pattern 865, because their corner points are all on the same plane in the physical world.

Further, assume that a physical point x=(x,y,z,1)^{T} is projected into uₘ=(uₘ,vₘ,1)^{T} by uₘ=λₘAₘPx, where P is the projection matrix of lens m, which is unknown. In one embodiment, uₘ is corrected as if it was seen from the n^{th} lens, by computing uₙ as uₙ=λₙAₙR^{mn}Px.

Now, uₙ=λₙAₙR^{mn}(λₘAₘ)⁻¹uₘ=(λₙ/λₘ)AₙR^{mn}Aₘ⁻¹uₘ, where (λₙ/λₘ) is a normalization factor of homogeneous coordinates, which leads to correction of a 3D rotation among lens by merely using a 2D pixel position of any input image.

Continuing with method 850, at block 857, re-stitching of image patches is performed by reposition and rescaling. In one embodiment, upon performing correction of inter-lens rotations at block 855, the image patches are not re-positioned and re-scaled so that all pixels at the stitching boundary may correspond to the same coordinates in the physical world, such as continuity at stitching boundary 869. Further, a scaling factor and a translation offset are chosen to achieve a largest coverage with the original image size.

It is contemplated and to be noted that R^{mn} is a constant and P is not used in the above process. The un-distortion process is therefore identical in all frames from a still camera. This enables pre-computing of the un-distortion process and building of a look-up table for pixel coordinate mapping between the original image and its undistorted version, which improves the computational efficiency of lens un-distortion.

FIG. 9A illustrates a method 900 for whiteboard occlusion removal according to one embodiment. Method 900 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 900 are illustrated in linear sequences for brevity and clarity in presentation; however, it is contemplated that any number of them can be performed in parallel, asynchronously, or in different orders. For brevity, many of the details discussed with reference to the previous FIGS. 1-8B may not be discussed or repeated hereafter.

Method 900 begins at block 901 with receiving and analyzing of a camera input, which includes a panoramic image of a whiteboard in a room, where the image is captured by a camera of a computing device placed in the room. At block 903, background edges are determined from using the input frame and an edge mask is created consisting merely the background edges. At block 905, any background edge pixel information is captured. Referring back to block 901, the input frame is initialized and a background frame model is created at block 907. Using the background frame model along with the edge mask of block 903 and pixel color history from block 905, at block 909, an output frame is created, while the background frame model is updated. At block 911, the output frame is retrieved and communicated on to one or more of computing devices 250A-N over one or more communication medium(s) 230 of FIG. 2.

FIG. 9B illustrates a method 920 for facilitating creation of an edge mask according to one embodiment. Method 920 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 920 are illustrated in linear sequences for brevity and clarity in presentation; however, it is contemplated that any number of them can be performed in parallel, asynchronously, or in different orders. For brevity, many of the details discussed with reference to the previous FIGS. 1-9A may not be discussed or repeated hereafter.

Method 920 begins at block 921 with receiving and analyzing of a camera input, which includes a panoramic image of a whiteboard in a room, where the image is captured by a camera of a computing device placed in the room. At block 923, all edges from the input frame are detected, the age counter for all the pixels of edges is incremented. At block 925, a foreground mask is prepared, while at block 927, a background frame model is maintained. As previously discussed with respect to FIG. 2, with regard to the background edges, in one embodiment, those edges that appear at the same pixel location for longer than the edge detection threshold (e.g., a number of frames, such as 70 frames) may be classified as background edges.

In one embodiment, at block 929, an occluded background edge pixels set is created, while at block 931, an edge mask is generated. If an edge that was previously classified as a background edge is missing in the current frame, then it may be either occluded by a foreground object or erased by the user. The edges that are occluded by the foreground object are identified and set in the edge mask. Further, to handle the background edges being occluded by the foreground object, one or more of the following may be performed: 1) remove the background edges in the current edge mask; 2) extract the contour of the region formed by the remaining edges as the foreground mask; and 3) set the background edges that are missing in the current frame and also part of the foreground mask. If the missing background edge is part of a foreground mask, then the assumption is made that it is being occluded and not erased by the user. From the edge mask, those edges whose age counter is less than the threshold value are cleared. In one embodiment, from edge mask of block 931, those edges whose age counter is less than the threshold value are cleared.

FIG. 9C illustrates a method 940 for facilitating creation of an output frame according to one embodiment. Method 940 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 940 are illustrated in linear sequences for brevity and clarity in presentation; however, it is contemplated that any number of them can be performed in parallel, asynchronously, or in different orders. For brevity, many of the details discussed with reference to the previous FIGS. 1-9B may not be discussed or repeated hereafter.

Method 940 begins at block 941 with receiving and analyzing of a camera input, which includes a panoramic image of a whiteboard in a room, where the image is captured by a camera of a computing device placed in the room. At block 943, all edges are detected and at block 945, a foreground mask is created. At block 947, an occluded background edge pixels set is generated, while, at block 949, an edge mask is created.

In one embodiment, an output frame is generated and initialized with zeros. Using the edge mask of block 949 and pixel color history table, the output frame is filled with the background edge pixels. Then, any remaining pixels are filled with pixels from a background frame model of block 951. For the background edges that are missing in the edge mask of block 949, the pixels are replaced with the pixels of the current frame. At block 951, the background model frame is updated and, at block 953, the output frame is update and returned to be communicated on to one or more computing devices 250A-N of FIG. 2.

FIG. 10A illustrates a panoramic image 1000 of a conference room according to one embodiment. As an initial matter, for brevity, many of the details discussed with reference to the previous FIGS. 1-9C may not be discussed or repeated hereafter. In the illustrated embodiment, panoramic image 1000 provides a panoramic view of the conference room, where this panoramic view is captured using one or more panoramic cameras of camera(s) 241 of FIG. 2. This panoramic image 1000 may be used to enable remote users, such as one or more users of one or more computing devices 250A-N of FIG. 2, to have a view of whiteboard 270 and other objects of interest, focus on the local attendees present in the conference room, where whiteboard 270 is identified and rectified using whiteboard identifiers 271 as used by whiteboard mechanism 110 of FIG. 2.

FIG. 10B illustrates a rectified whiteboard image 1020 of a whiteboard 270 in a conference room according to one embodiment. As an initial matter, for brevity, many of the details discussed with reference to the previous FIGS. 1-10A may not be discussed or repeated hereafter. In the illustrated embodiment, rectified whiteboard image 1020, as facilitated by rectification logic 205 of FIG. 2, is provided as showing a frontal-view of whiteboard 270 by correcting its geometrical distortions, where this rectified whiteboard image 1020 further shows whiteboard indicators 271.

FIG. 10C illustrates a contrast enhanced whiteboard image 1040 of a whiteboard 270 in a conference room according to one embodiment. As an initial matter, for brevity, many of the details discussed with reference to the previous FIGS. 1-10B may not be discussed or repeated hereafter. In one embodiment, rectified whiteboard image 1020 of FIG. 10B is further improved by enhancing it in its contrast for an even clearer view to obtain contrast enhanced whiteboard image 1040 as facilitated by enhancement logic 207 of FIG. 2.

As previously discussed with reference to FIG. 2, in one embodiment, enhancement logic 207 of FIG. 2 may be used for facilitating contrast enhancement by performing pixel-wise enhancement to avoid any block artifacts. For example, given the homogeneous background color of whiteboard 270, enhancement logic 207 of FIG. 2 may use the ratio between the pixel intensity and its locally averaged value as the clue for adaptively determining the level of enhancement. This ratio may be first logarithmically scaled to magnify the difference caused by the whiteboard contents of whiteboard 270. Further, in one embodiment, a novel function may be used by enhancement logic 207 of FIG. 2 to adaptively map the pixel value from the input image to its enhanced output such that to smooth minor noises, enhance medium gradients, and compress any dynamic range for large gradients, etc.

FIG. 11A illustrates a method 1100 for facilitating contrast enhancement on rectified images according to one embodiment. Method 1100 may be performed by processing logic that may comprise hardware (e.g., circuitry, dedicated logic, programmable logic, etc.), software (such as instructions run on a processing device), or a combination thereof, as facilitated by whiteboard mechanism 110 of FIG. 1. The processes of method 1100 are illustrated in linear sequences for brevity and clarity in presentation; however, it is contemplated that any number of them can be performed in parallel, asynchronously, or in different orders. For brevity, many of the details discussed with reference to the previous FIGS. 1-10C may not be discussed or repeated hereafter.

Method 1100 begins at block 1101 with receiving and analyzing of a rectified whiteboard image, as shown with reference to FIG. 10B, which is obtained from a camera input, which includes a panoramic image of a whiteboard in a room, as shown in FIG. 10A, where the image is captured by one or more cameras of or in communication with one or more computing devices placed in the room. At block 1103, a hue, saturation, and value (HSV) channel splitting is performed, where given a color image for the rectified whiteboard, the color image is first converted into an HSV color space. For example, in one embodiment, the HSV splitting provides processing for hue, saturation, and intensity at blocks 1105, 1107, and 1109, respectively.

Further, in one embodiment, using enhancement logic 207 of FIG. 2, adaptive contrast enhancement is performed on the V channel of block 1109 of the HSV channels. For example, at block 1111, morphological closing is performed by, at each pixel position, computing the background intensity from the average value in its neighborhood by assuming a homogeneous background of the whiteboard such that the average intensity may be computed by morphological closing or a low-pass filter, such as the Gaussian filter. At block 1113, logarithmic scaling of minor gradients is performed by, for example, determine a present contrast using deviation of the intensity obtained from a neighborhood average intensity. For example, letting the intensity image and its smoothed version after morphology closing be I and I^{Closed}, respectively, pixel values at position x-th column and y-th row may be defined as I_{xy} and I_{xy}^{Closed}. Further, present contrast R_{xy} may be defined by taking the logarithmic scaling of the ratio between I_{xy} and I_{xy}^{Closed} as:

$${R}_{xy} = log \frac{{I}_{xy}}{{I}_{xy}^{Closed}} .$$

This logarithmic scaling amplifies smaller difference between a pixel and its smoothed value, while suppressing large difference that has already been clear enough.

In one embodiment, at block 1115, curve remapping of minor gradients is performed, which then leads to obtaining enhanced intensity at block 1117. For example, with regard to curve remapping (at block 1115), mapping functions may be defined to then obtain the enhanced intensity value (at block 1117) for a given pixel by defining a mapping function to handle different levels of contrast in an adaptive way, which reads:

$${R}_{xy}^{Mapped} = \{ \begin{matrix}s exp ( - {kR}_{xy}^{2} ) , & {R}_{xy} \leq 0 \\ 2 - ( 2 - s ) exp ( - {kR}_{xy}^{2} ) , & {R}_{xy} > 0\end{matrix}$$

Here, s is a scaling factor, which elevates the global brightness of the whiteboard, and is defined as:

$$s = min ( 2 , \frac{{I}^{Target}}{{I}^{Average}} ) .$$

Here, I^{Average} and I^{Target} are the average brightness of the input image as well as its expected value, respectively.

In one embodiment, this mapping function R_{xy}^{Mapped} is plotted against R_xy, as illustrated with reference to FIG. 11B. It is contemplated that s exp(−kR_{xy}²) defines a bell-shaped curve, which may be used to: 1) smooth out minor variations, which is mainly due to noises in lighting conditions, encoding artifacts, etc.; 2) enlarge medium variations significantly with a sharp slope, which stand for unclear strokes, and other drawing contents we want to enhance; and 3) saturate large variations, which are from contents that are already clear enough in the original image.

Further, in one embodiment, the pixel value in the output image may be computed by:

I_{xy}^{New}=min(255, R_{sy}^{Mapped}I_{xy}).

For example, if the pixel takes the average intensity value of a flatten area, such as the whiteboard background, it may be enhanced by s as a global brightness improvement; otherwise, it is either smoothed or enhanced by R_{xy}^{Mapped} according to its present level of contrast.

At block 1119, the enhanced intensity value of block 117 is merged back into the HSV color-space along with hue of block 1105 and saturation of block 1107 to produce a resultant color image of the whiteboard content through color correction at block 1121. At block 1123, an enhanced whiteboard image is produced and communicated over to one or more of computing devices 250A-N over one or more communication medium(s) 230 of FIG. 2.

FIG. 11B illustrates a graph 1150 of a mapping function used in contrast enhancement of FIG. 11A according to one embodiment. As an initial matter, for brevity, many of the details discussed with reference to the previous FIGS. 1-11A may not be discussed or repeated hereafter.

As discussed with reference to FIG. 11A, one or more mapping functions may be used to perform and achieve contrast enhancement on rectified images of whiteboard contents of a whiteboard in a room. In one embodiment, as further detailed in FIG. 11A, one of those mapping function may include plotting R_{xy}^{Mapped} against R_xy, as illustrated here in graph 1150, which may be used to achieve the desired or necessitated contrast enhancement.

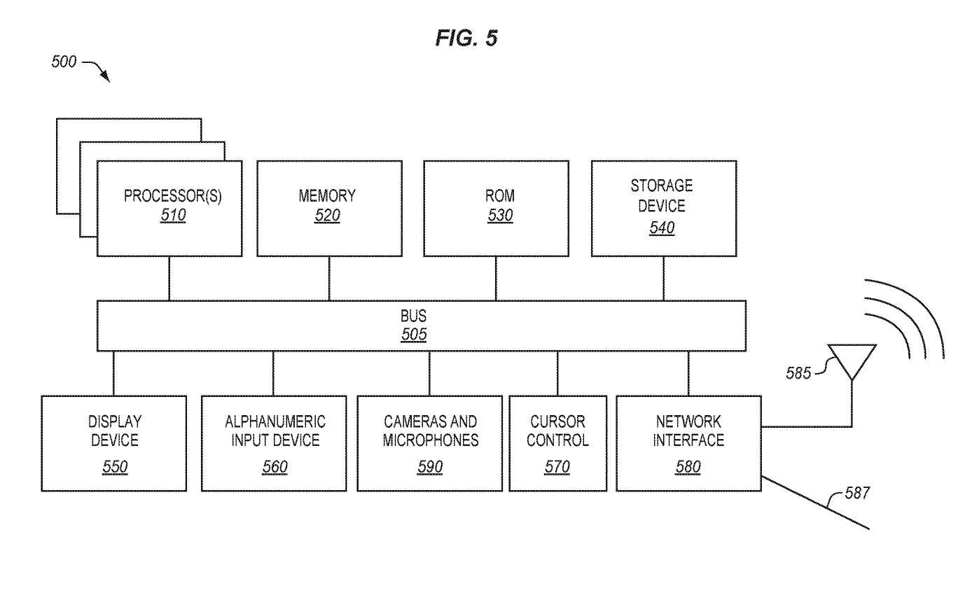

Now referring to FIG. 5, it illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

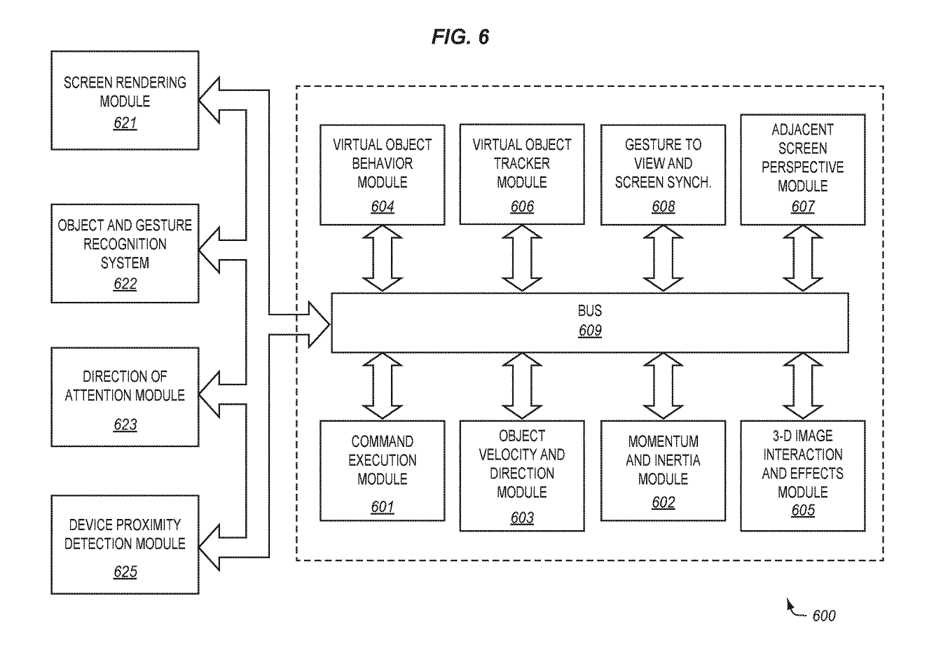

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate smart capturing of whiteboard contents, the apparatus comprising: one or more cameras to capture one or more images of one or more boards; identification/extraction logic to identify a target board of the one or more boards using one or more indicators associated with the target board, wherein the identification/extraction logic is further to extract a region encompassing the target board; estimation logic to estimate scene geometry based on the region; and rectification logic to generate a rectified image of the target board based on the scene geometry.

Example 2 includes the subject matter of Example 1, further comprising: enhancement logic to enhance the rectified image into a final image of the target board, wherein the final image to offer enhanced view of contents of the target board; communication/interfacing logic to communicate the final image of the target board to one or more computing devices, wherein the final image is capable of being viewed on the one or more computing devices using one or more user interfaces, wherein the one or more computing devices and the apparatus are communicatively part of a network; and compatibility/resolution logic to dynamically facilitate at least one of compatibility or conflict resolution between one or more of the apparatus, the one or more computing devices, and the network, wherein the network includes at least one of a cloud network, a proximity network, and the Internet.

Example 3 includes the subject matter of Example 1, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

Example 4 includes the subject matter of Example 1, wherein the scene geometry to identify vanishing points of the target board with respect to one or more corners or edges of the target board, wherein the estimation logic is further to estimate a target size of the target board based on the reference indicator size and the region.

Example 5 includes the subject matter of Example 1, wherein the rectified image is generated to correct one or more deficiencies identified in the scene geometry to provide a frontal view of the target board, wherein the one or more deficiencies comprise geometric distortions or lens distortions.

Example 6 includes the subject matter of Example 2 or 5, wherein the rectified image is enhanced into the final image to clarify the contents of the target board, wherein the contents include writing or printing inscribed on the target board.

Example 7 includes the subject matter of Example 1, further comprising: generation and removal logic to generate a file identifying a set of distortions in a stitched panoramic image, wherein the generation and removal logic is further to remove the set of distortions from the stitched panoramic image; and in response to the removal of the set of distortions, stitching logic to re-stitch one or more patches of the stitched panoramic image into a newly stitched panoramic image.

Example 8 includes the subject matter of Example 1, further comprising occlusion-free logic to identify one or more foreground objects with respect to a background represented by the region, wherein the one or more foreground objects include occluding objects obscuring at least a portion of the target board.

Example 9 includes the subject matter of Example 8, wherein the occlusion-free logic is further to: identify background pixels from a history of a plurality of pixels, wherein one or more of the plurality of pixels are classified as the background pixels for being in a same pixel location over a predetermined period of time; and replace the one or more foreground objects with the background pixels, wherein the one or more foreground objects are noisy and distinct for not being in the same pixel location over the predetermined period of time.

Some embodiments pertain to Example 10 that includes a method for facilitating smart capturing of whiteboard contents, the method comprising: capturing, by one or more cameras of a computing device, one or more images of one or more boards; identifying a target board of the one or more boards using one or more indicators associated with the target board, wherein identifying the target board includes extracting a region encompassing the target board; estimating scene geometry based on the region; and generating a rectified image of the target board based on the scene geometry.

Example 11 includes the subject matter of Example 10, further comprising: enhancing the rectified image into a final image of the target board, wherein the final image to offer enhanced view of contents of the target board; communicating the final image of the target board to one or more computing devices, wherein the final image is capable of being viewed on the one or more computing devices using one or more user interfaces, wherein the one or more computing devices and the computing device are communicatively part of a network; and dynamically facilitating at least one of compatibility or conflict resolution between one or more of the computing device, the one or more computing devices, and the network, wherein the network includes at least one of a cloud network, a proximity network, and the Internet.

Example 12 includes the subject matter of Example 10, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

Example 13 includes the subject matter of Example 10, wherein the scene geometry to identify vanishing points of the target board with respect to one or more corners or edges of the target board, wherein estimating the scene geometry further includes estimating a target size of the target board based on the reference indicator size and the region.

Example 14 includes the subject matter of Example 10, wherein the rectified image is generated to correct one or more deficiencies identified in the scene geometry to provide a frontal view of the target board, wherein the one or more deficiencies comprise geometric distortions or lens distortions.

Example 15 includes the subject matter of Example 11 or 14, wherein the rectified image is enhanced into the final image to clarify the contents of the target board, wherein the contents include writing or printing inscribed on the target board.

Example 16 includes the subject matter of Example 10, further comprising: generating a file identifying a set of distortions in a stitched panoramic image; removing the set of distortions from the stitched panoramic image; and in response to the removal of the set of distortions, re-stitching one or more patches of the stitched panoramic image into a newly stitched panoramic image.

Example 17 includes the subject matter of Example 10, further comprising identifying one or more foreground objects with respect to a background represented by the region, wherein the one or more foreground objects include occluding objects obscuring at least a portion of the target board.

Example 18 includes the subject matter of Example 17, further comprising: identifying background pixels from a history of a plurality of pixels, wherein one or more of the plurality of pixels are classified as the background pixels for being in a same pixel location over a predetermined period of time; and replacing the one or more foreground objects with the background pixels, wherein the one or more foreground objects are noisy and distinct for not being in the same pixel location over the predetermined period of time.

Some embodiments pertain to Example 19 includes a system comprising a computing system including a storage device having instructions, and a processor to execute the instructions to facilitate a mechanism to: capture, by one or more cameras of a computing device, one or more images of one or more boards; identify a target board of the one or more boards using one or more indicators associated with the target board, wherein identifying the target board includes extracting a region encompassing the target board; estimate scene geometry based on the region; and generate a rectified image of the target board based on the scene geometry.

Example 20 includes the subject matter of Example 19, wherein the mechanism is further to: enhance the rectified image into a final image of the target board, wherein the final image to offer enhanced view of contents of the target board; communicate the final image of the target board to one or more computing devices, wherein the final image is capable of being viewed on the one or more computing devices using one or more user interfaces, wherein the one or more computing devices and the computing device are communicatively part of a network; and dynamically facilitate at least one of compatibility or conflict resolution between one or more of the computing device, the one or more computing devices, and the network, wherein the network includes at least one of a cloud network, a proximity network, and the Internet.

Example 21 includes the subject matter of Example 19, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

Example 22 includes the subject matter of Example 19, wherein the scene geometry to identify vanishing points of the target board with respect to one or more corners or edges of the target board, wherein estimating the scene geometry further includes estimating a target size of the target board based on the reference indicator size and the region.

Example 23 includes the subject matter of Example 19, wherein the rectified image is generated to correct one or more deficiencies identified in the scene geometry to provide a frontal view of the target board, wherein the one or more deficiencies comprise geometric distortions or lens distortions.

Example 24 includes the subject matter of Example 20 or 23, wherein the rectified image is enhanced into the final image to clarify the contents of the target board, wherein the contents include writing or printing inscribed on the target board.

Example 25 includes the subject matter of Example 19, wherein the mechanism is further to: generate a file identifying a set of distortions in a stitched panoramic image; remove the set of distortions from the stitched panoramic image; and in response to the removal of the set of distortions, re-stitch one or more patches of the stitched panoramic image into a newly stitched panoramic image.

Example 26 includes the subject matter of Example 19, wherein the mechanism is further to identify one or more foreground objects with respect to a background represented by the region, wherein the one or more foreground objects include occluding objects obscuring at least a portion of the target board.

Example 27 includes the subject matter of Example 26, wherein the mechanism is further to: identify background pixels from a history of a plurality of pixels, wherein one or more of the plurality of pixels are classified as the background pixels for being in a same pixel location over a predetermined period of time; and replace the one or more foreground objects with the background pixels, wherein the one or more foreground objects are noisy and distinct for not being in the same pixel location over the predetermined period of time.

Some embodiments pertain to Example 28 includes an apparatus comprising: means for capturing, by one or more cameras of a computing device, one or more images of one or more boards; means for identifying a target board of the one or more boards using one or more indicators associated with the target board, wherein identifying the target board includes extracting a region encompassing the target board; means for estimating scene geometry based on the region; and means for generating a rectified image of the target board based on the scene geometry.

Example 29 includes the subject matter of Example 28, further comprising: means for enhancing the rectified image into a final image of the target board, wherein the final image to offer enhanced view of contents of the target board; means for communicating the final image of the target board to one or more computing devices, wherein the final image is capable of being viewed on the one or more computing devices using one or more user interfaces, wherein the one or more computing devices and the computing device are communicatively part of a network; and means for dynamically facilitating at least one of compatibility or conflict resolution between one or more of the computing device, the one or more computing devices, and the network, wherein the network includes at least one of a cloud network, a proximity network, and the Internet.

Example 30 includes the subject matter of Example 28, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

Example 31 includes the subject matter of Example 28, wherein the scene geometry to identify vanishing points of the target board with respect to one or more corners or edges of the target board, wherein estimating the scene geometry further includes estimating a target size of the target board based on the reference indicator size and the region.

Example 32 includes the subject matter of Example 28, wherein the rectified image is generated to correct one or more deficiencies identified in the scene geometry to provide a frontal view of the target board, wherein the one or more deficiencies comprise geometric distortions or lens distortions.

Example 33 includes the subject matter of Example 29 or 32, wherein the rectified image is enhanced into the final image to clarify the contents of the target board, wherein the contents include writing or printing inscribed on the target board.

Example 34 includes the subject matter of Example 28, further comprising: means for generating a file identifying a set of distortions in a stitched panoramic image; means for removing the set of distortions from the stitched panoramic image; and in response to the removal of the set of distortions, means for re-stitching one or more patches of the stitched panoramic image into a newly stitched panoramic image.

Example 35 includes the subject matter of Example 28, further comprising means for identifying one or more foreground objects with respect to a background represented by the region, wherein the one or more foreground objects include occluding objects obscuring at least a portion of the target board.

Example 36 includes the subject matter of Example 35, further comprising: means for identifying background pixels from a history of a plurality of pixels, wherein one or more of the plurality of pixels are classified as the background pixels for being in a same pixel location over a predetermined period of time; and means for replacing the one or more foreground objects with the background pixels, wherein the one or more foreground objects are noisy and distinct for not being in the same pixel location over the predetermined period of time.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
one or more cameras to capture one or more images of one or more boards;
identification/extraction logic to identify a target board of the one or more boards using one or more indicators associated with the target board, wherein the identification/extraction logic is further to extract a region encompassing the target board;
estimation logic to estimate scene geometry based on the region; and
rectification logic to generate a rectified image of the target board based on the scene geometry.

2. The apparatus of claim 1, further comprising:
enhancement logic to enhance the rectified image into a final image of the target board, wherein the final image to offer enhanced view of contents of the target board;
communication/interfacing logic to communicate the final image of the target board to one or more computing devices, wherein the final image is capable of being viewed on the one or more computing devices using one or more user interfaces, wherein the one or more computing devices and the apparatus are communicatively part of a network; and
compatibility/resolution logic to dynamically facilitate at least one of compatibility or conflict resolution between one or more of the apparatus, the one or more computing devices, and the network, wherein the network includes at least one of a cloud network, a proximity network, and the Internet.

3. The apparatus of claim 1, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

4. The apparatus of claim 1, wherein the scene geometry to identify vanishing points of the target board with respect to one or more corners or edges of the target board, wherein the estimation logic is further to estimate a target size of the target board based on the reference indicator size and the region.

5. The apparatus of claim 1, wherein the rectified image is generated to correct one or more deficiencies identified in the scene geometry to provide a frontal view of the target board, wherein the one or more deficiencies comprise geometric distortions or lens distortions.

6. The apparatus of claim 2, wherein the rectified image is enhanced into the final image to clarify the contents of the target board, wherein the contents include writing or printing inscribed on the target board.

7. The apparatus of claim 1, further comprising:
generation and removal logic to generate a file identifying a set of distortions in a stitched panoramic image, wherein the generation and removal logic is further to remove the set of distortions from the stitched panoramic image; and
in response to the removal of the set of distortions, stitching logic to re-stitch one or more patches of the stitched panoramic image into a newly stitched panoramic image.

8. The apparatus of claim 1, further comprising occlusion-free logic to identify one or more foreground objects with respect to a background represented by the region, wherein the one or more foreground objects include occluding objects obscuring at least a portion of the target board.

9. The apparatus of claim 8, wherein the occlusion-free logic is further to:
identify background pixels from a history of a plurality of pixels, wherein one or more of the plurality of pixels are classified as the background pixels for being in a same pixel location over a predetermined period of time; and
replace the one or more foreground objects with the background pixels, wherein the one or more foreground objects are noisy and distinct for not being in the same pixel location over the predetermined period of time.

10. A method comprising:
capturing, by one or more cameras of a computing device, one or more images of one or more boards;
identifying a target board of the one or more boards using one or more indicators associated with the target board, wherein identifying the target board includes extracting a region encompassing the target board;
estimating scene geometry based on the region; and
generating a rectified image of the target board based on the scene geometry.

11. The method of claim 10, further comprising:
enhancing the rectified image into a final image of the target board, wherein the final image to offer enhanced view of contents of the target board;
communicating the final image of the target board to one or more computing devices, wherein the final image is capable of being viewed on the one or more computing devices using one or more user interfaces, wherein the one or more computing devices and the computing device are communicatively part of a network; and
dynamically facilitating at least one of compatibility or conflict resolution between one or more of the computing device, the one or more computing devices, and the network, wherein the network includes at least one of a cloud network, a proximity network, and the Internet.

12. The method of claim 10, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

13. The method of claim 10, wherein the scene geometry to identify vanishing points of the target board with respect to one or more corners or edges of the target board, wherein estimating the scene geometry further includes estimating a target size of the target board based on the reference indicator size and the region.

14. The method of claim 10, wherein the rectified image is generated to correct one or more deficiencies identified in the scene geometry to provide a frontal view of the target board, wherein the one or more deficiencies comprise geometric distortions or lens distortions.

15. The method of claim 11, wherein the rectified image is enhanced into the final image to clarify the contents of the target board, wherein the contents include writing or printing inscribed on the target board.

16. The method of claim 10, further comprising:
generating a file identifying a set of distortions in a stitched panoramic image;
removing the set of distortions from the stitched panoramic image; and
in response to the removal of the set of distortions, re-stitching one or more patches of the stitched panoramic image into a newly stitched panoramic image.

17. The method of claim 10, further comprising identifying one or more foreground objects with respect to a background represented by the region, wherein the one or more foreground objects include occluding objects obscuring at least a portion of the target board.

18. The method of claim 17, further comprising:
identifying background pixels from a history of a plurality of pixels, wherein one or more of the plurality of pixels are classified as the background pixels for being in a same pixel location over a predetermined period of time; and
replacing the one or more foreground objects with the background pixels, wherein the one or more foreground objects are noisy and distinct for not being in the same pixel location over the predetermined period of time.

19. At least one machine-readable medium comprising instructions which, when executed by a processing device, cause the processing device to:
capture, by one or more cameras of the processing device, one or more images of one or more boards;
identify a target board of the one or more boards using one or more indicators associated with the target board, wherein identifying the target board includes extracting a region encompassing the target board;
estimate scene geometry based on the region; and
generate a rectified image of the target board based on the scene geometry.

20. The machine-readable medium of claim 19, wherein the processing device is further to:
enhance the rectified image into a final image of the target board, wherein the final image to offer enhanced view of contents of the target board;
communicate the final image of the target board to one or more computing devices, wherein the final image is capable of being viewed on the one or more computing devices using one or more user interfaces, wherein the one or more computing devices and the processing device are communicatively part of a network; and
dynamically facilitate at least one of compatibility or conflict resolution between one or more of the processing device, the one or more computing devices, and the network, wherein the network includes at least one of a cloud network, a proximity network, and the Internet.

21. The machine-readable medium of claim 19, wherein the indicators are handwritten or printed on target board, wherein a collection of the indicators to indicate a reference indicator size, wherein the target board includes one or more of a hard board or a soft board, wherein the hard board is made with hard material including one or more of metal, hard plastic, and wood, wherein the soft board is made with soft material including one or more of soft plastic and paper.

22. The machine-readable medium of claim 19, wherein the scene geometry to identify vanishing points of the target board with respect to one or more corners or edges of the target board, wherein estimating the scene geometry further includes estimating a target size of the target board based on the reference indicator size and the region.

23. The machine-readable medium of claim 19, wherein the rectified image is generated to correct one or more deficiencies identified in the scene geometry to provide a frontal view of the target board, wherein the one or more deficiencies comprise geometric distortions or lens distortions, wherein the rectified image is enhanced into the final image to clarify the contents of the target board, wherein the contents include writing or printing inscribed on the target board.

24. The machine-readable medium of claim 19, wherein the processing device is further to:
generate a file identifying a set of distortions in a stitched panoramic image;
remove the set of distortions from the stitched panoramic image; and
in response to the removal of the set of distortions, re-stitch one or more patches of the stitched panoramic image into a newly stitched panoramic image.

25. The machine-readable medium of claim 19, further comprising:
identify one or more foreground objects with respect to a background represented by the region, wherein the one or more foreground objects include occluding objects obscuring at least a portion of the target board;
identify background pixels from a history of a plurality of pixels, wherein one or more of the plurality of pixels are classified as the background pixels for being in a same pixel location over a predetermined period of time; and
replace the one or more foreground objects with the background pixels, wherein the one or more foreground objects are noisy and distinct for not being in the same pixel location over the predetermined period of time.
